(19) United States
(12) Patent Application Publication
(10) Pub. No.: US 2008/0093506 A1
(43) Pub. Date: Apr. 24, 2008

(54) Spacecraft Thruster

(75) Inventors: Gregory Emsellem, Bourg La Reine (FR); Serge Larigaldie, Chatillon (FR)

Correspondence Address: HARNESS, DICKEY & PIERCE, P.L.C., P.O. BOX 828, BLOOMFIELD HILLS, MI, 48303, US

(73) Assignee: ELWING LLC, Wilmington, DE (US)

(21) Appl. No.: 11/663,025

(22) PCT Filed: Sep. 21, 2005
(86) PCT No.: PCT/US05/33632

§ 371 Date: Mar. 15, 2007

(30) Foreign Application Priority Data
Sep. 22, 2004 (EP) 04292270.8

(51) Int. Cl. B64G 1/26

(52) U.S. Cl. 244/169; 244/173.1; 60/200.1

(57) ABSTRACT

A thruster (1) has a main chamber (6) defined within a tube (2). The tube has a longitudinal axis which defines an axis (4) of thrust; an injector (8) injects ionizable gas within the tube, at one end of the main chamber. An ionizer (124) is adapted to ionize the injected gas within the main chamber (6). A first magnetic field generator (12, 14) and an electromagnetic field generator (18) are adapted to generate a magnetized ponderomotive accelerating field downstream of said ionizer (124) along the direction of thrust on said axis (4),

The thruster (1) ionizes the gas, and subsequently accelerates both electrons and ions by the magnetized ponderomotive force.

### BACKGROUND AND SUMMARY OF THE INVENTION

The invention relates to the field of thrusters. Thrusters are used for propelling spacecrafts, with a typical exhaust velocity ranging from 2 km/s to more than 50 km/s, and density of thrust below or around 1 N/m². In the absence of any material on which the thruster could push or lean, thrusters rely on the ejection of part of the mass of the spacecraft. The ejection speed is a key factor for assessing the efficiency of a thruster, and should typically be maximized.

Various solutions were proposed for spatial thrusters. U.S. Pat. No. 5,241,244 discloses a so-called ionic grid thruster. In this device, the propelling gas is first ionized, and the resulting ions are accelerated by a static electromagnetic field created between grids. The accelerated ions are neutralized with a flow of electrons. For ionizing the propelling gas, this document suggests using simultaneously a magnetic conditioning and confinement field and an electromagnetic field at the ECR (electron cyclotron resonance) frequency of the magnetic field. A similar thruster is disclosed in FR-A-2 799 576, induction being used for ionizing the gas. This type of thruster has an ejection speed of some 30 km/s, and a density of thrust of less than 1 N/m² for an electrical power of 2.5 kW.

One of the problems of this type of device is the need for a very high voltage between the accelerating grids. Another problem is the erosion of the grids due to the impact of ions. Last, neutralizers and grids are generally very sensitive devices.

U.S. Pat. No. 5,581,155 discloses a Hall effect thruster. This thruster also uses an electromagnetic field for accelerating positively-charged particles. The ejection speed in this type of thruster is around 15 km/s, with a density of thrust of less than 5 N/m² for a power of 1.3 kW. Like in ionic grid thruster, there is a problem of erosion and the presence of neutralizer makes the thruster prone to failures.

U.S. Pat. No. 6,205,769 or D. J. Sullivan et al., Development of a microwave resonant cavity electrothermal thruster prototype, IEPC 1993, n°36, pp. 337-354 discuss microwave electrothermal thrusters. These thrusters rely on the heating of the propelling gas by a microwave field. The heated gas is ejected through a nozzle to produce thrust. This type of thruster has an ejection speed of some 9-12 km/s, and a thrust from 200 to 2000 N.

D. A. Kaufman et al., Plume characteristic of an ECR plasma thruster, IEPC 1993 n°37, pp. 355-360 and H. Tabara et al., Performance characteristic of a space plasma simulator using an electron cyclotron resonance plasma accelerator and its application to material and plasma interaction research, IEPC 1997 n° 163, pp. 994-1000 discuss ECR plasma thrusters. In such a thruster, a plasma is created using electron cyclotron resonance in a magnetic nozzle. The electrons are accelerated axially by the magnetic dipole moment force, creating an electric field that accelerates the ions and produces thrust. In other words, the plasma flows naturally along the field lines of the decreasing magnetic field. This type of thruster has an ejection speed up to 35 km/s. U.S. Pat. No. 6,293,090 discusses a RF plasma thruster; its works according to the same principle, with the main difference that the plasma is created by a lower hybrid wave, instead of using an ECR field.

U.S. Pat. No. 6,334,302 and F. R. Chang-Diaz, Design characteristic of the variable I_{SP} plasma rocket, IEPC 1991, n° 128, disclose variable specific impulse magnetoplasma thruster (in short VaSIMR). This thruster uses a three stage process of plasma injection, heating and controlled exhaust in a magnetic tandem mirror configuration. The source of plasma is a helicon generator and the plasma heater is a cyclotron generator. The nozzle is a radially diverging magnetic field. As in ECR or RF plasma thruster, ionized particles are not accelerated, but flow along the lines of the decreasing magnetic field. This type of thruster has an ejection speed of some 10 to 300 km/s, and a thrust of 50 to 1000 N.

In a different field, U.S. Pat. No. 4,641,060 and U.S. Pat. No. 5,442,185 discuss ECR plasma generators, which are used for vacuum pumping or for ion implantation. Another example of a similar plasma generator is given in U.S. Pat. No. 3,160,566.

U.S. Pat. No. 3,571,734 discusses a method and a device for accelerating particles. The purpose is to create a beam of particles for fusion reactions. Gas is injected into a cylindrical resonant cavity submitted to superimposed axial and radial magnetic fields. An electromagnetic field at the ECR frequency is applied for ionizing the gas. The intensity of magnetic field decreases along the axis of the cavity, so that ionized particles flow along this axis. This accelerating device is also discloses in the Compte Rendu de l'Académie des Sciences, Nov. 4, 1963, vol. 257, p. 2804-2807. The purpose of these devices is to create a beam of particles for fusion reactions: thus, the ejection speed is around 60 km/s, but the density of thrust is very low, typically below 1.5 N/m².

U.S. Pat. No. 3,425,902 discloses a device for producing and confining ionized gases. The magnetic field is maximum at both ends of the chamber where the gases are ionized.

European patent application EP-03290712 discloses a thruster using ponderomotive force thrust. FIG. 1 is a schematic view in cross-section of a thruster of the prior art. The thruster 1 of FIG. 1 relies on electron cyclotron resonance for producing a plasma, and on magnetized ponderomotive force for accelerating this plasma for producing thrust. The ponderomotive force is the force exerted on a plasma due to a gradient in the density of a high frequency electromagnetic field. This force is discussed in H. Motz and C. J. H. Watson (1967), Advances in electronics and electron physics 23, pp. 153-302. In the absence of a magnetic field, this force may be expressed as

$$F = - \frac{{q}^{2}}{4 m {ω}^{2}} ∇ {E}^{2}$$

for one particle

$$F = - \frac{{ω}_{p}^{2}}{2 {ω}^{2}} ∇ \frac{{ɛ}_{0} {E}^{2}}{2}$$

for the plasma with

$${ω}_{p}^{2} = \frac{{nⅇ}^{2}}{{m}_{e} {ɛ}_{0}}$$

In presence of a non-uniform magnetic field this force can be expressed as:

$$F = - \frac{{q}^{2}}{4 m ω} ( \frac{∇ {E}^{2}}{( ω - {Ω}_{c} )} - \frac{{E}^{2}}{{( ω - {Ω}_{c} )}^{2}} ∇ {Ω}_{c} ) - μ ∇ B$$

The device of FIG. 1 comprises a tube 2. The tube has a longitudinal axis 4 which defines an axis of thrust; indeed, the thrust produced by the thruster 1 is directed along this axis—although it may be guided as explained below in reference to FIGS. 10 to 13. The inside of the tube defines a chamber 6, in which the propelling gas is ionized and accelerated.

In the example of FIG. 1, the tube is a cylindrical tube. It is made of a non-conductive material for allowing magnetic and electromagnetic fields to be produced within the chamber; one may use low permittivity ceramics, quartz, glass or similar materials. The tube may also be in a material having a high rate of emission of secondary electrons, such as BN, Al₂O₃, B₄C. This increases electronic density in the chamber and improves ionization.

The tube extends continuously along the thruster 1, gas being injected at one end of the tube. One could however contemplate various shapes for the tube. For instance, the cross-section of the tube, which is circular in this example, could have another shape, according to the plasma flow needed at the output of the thruster 1. Also, there is no need for the tube to extend continuously between the injector and the output of the thruster 1 (in which case the tube can be made of metals or alloys such as steel, W, Mo, Al, Cu, Th—W or Cu—W, which can also be impregnated or coated with Barium Oxide or Magnesium Oxide, or include radioactive isotope to enhance ionization): as discussed below, the plasma are not confined by the tube, but rather by the magnetic and electromagnetic fields applied in the thruster 1. Thus, the tube could comprise two separate sections, while the chamber would still extend along the thruster 1, between the two sections of the tube.

At one end of the tube is provided an injector 8. The injector injects ionizable gas into the tube, as represented in FIG. 1 by arrow 10. The gas may comprise inert gazes Xe, Ar, Ne, Kr, He, chemical compounds as H₂, N₂, NH₃, N₂H₂, H₂O or CH₄ or even metals like Cs, Na, K or Li (alkali metals) or Hg. The most commonly used are Xe and H₂, which need the less energy for ionization.

The thruster 1 further comprises a magnetic field generator, which generates a magnetic field in the chamber 6. In the example of FIG. 1, the magnetic field generator comprises two coils 12 and 14. These coils produce within chamber 6 a magnetic field B, the longitudinal component of which is represented on FIG. 2. As shown on FIG. 2, the longitudinal component of the magnetic field has two maxima, the position of which corresponds to the coils. The first maximum Bₘₐₓ₁, which corresponds to the first coil 12, is located proximate the injector. It only serves for confining the plasma, and is not necessary for the operation of the thruster 1. However, it has the advantage of longitudinally confining the plasma electrons, so that ionization is easier by a magnetic bottle effect; in addition, the end of the tube and the injector nozzle are protected against erosion. The second maximum Bₘₐₓ₂, corresponding to the second coil 14, makes it possible to confine the plasma within the chamber. It also separates the ionization volume of the thruster 1—upstream of the maximum from the acceleration volume—downstream of the first maximum. The value of the longitudinal component of the magnetic field at this maximum may be adapted as discussed below. Between the two maxima—or downstream of the second maximum where the gas is injected, the magnetic field has a lower value. In the example of FIG. 1, the magnetic field has a minimum value Bₘᵢₙ substantially in the middle of the chamber.

In the ionization volume of the thruster 1—between the two maxima of the magnetic field in the example of FIG. 1—the radial and orthoradial components of the magnetic field—that is the components of the magnetic field in a plane perpendicular to the longitudinal axis of the thruster 1—are of no relevance to the operation of the thruster 1; they preferably have a smaller intensity than the longitudinal component of the magnetic field. Indeed, they may only diminish the efficiency of the thruster 1 by inducing unnecessary motion toward the walls of the ions and electrons within the chamber.

In the acceleration volume of the thruster 1—that is one right side, i.e. downstream, of the second maximum Bₘₐₓ₂ of the magnetic field in the example of FIG. 1—the direction of the magnetic field substantially gives the direction of thrust. Thus, the magnetic field is preferably along the axis of the thrust. The radial and orthoradial components of the magnetic field are preferably as small as possible.

Thus, in the ionization volume as well as in the acceleration volume, the magnetic field is preferably substantially parallel to the axis of the thruster 1. The angle between the magnetic field and the axis 4 of the thruster 1 is preferably less than 45°, and more preferably less than 20°. In the example of FIGS. 1 and 2, this angle is substantially 0°, so that the diagram of FIG. 2 corresponds not only to the intensity of the magnetic field plotted along the axis of the thruster 1, but also to the axial component of the magnetic field.

The intensity of the magnetic field generated by the magnetic field generator—that is the values Bₘₐₓ₁, Bₘₐₓ₂ and Bₘᵢₙ—are preferably selected as follows. The maximum values are selected to allow the electrons of the plasma to be confined in the chamber; the higher the value of the mirror ratio Bₘₐₓ/Bₘᵢₙ, the better the electrons are confined in the chamber. The value may be selected according to the (mass flow rate) thrust density wanted and to the power of the electromagnetic ionizing field (or the power for a given flow rate), so that 90% or more of the gas is ionized after passing the second peak of magnetic field. The lower value Bₘᵢₙ depends on the position of the coils. It does not have much relevance, except in the embodiment of FIGS. 4 and 5. The fraction of electron lost from the bottle in percent can be expressed as:

$${α}_{lost} = 1 - \sqrt{1 - \frac{{B}_{min}}{{B}_{max}}} or \frac{{B}_{max}}{{B}_{min}} = \frac{1}{1 - {( 1 - {α}_{lost} )}^{2}}$$

For a given mass flow, and for a given thrust, a smaller αₗₒₛₜ allows reducing the ionizing power for the same flow rate and ionization fraction.

In addition, the magnetic field is preferably selected so that ions are mostly insensitive to the magnetic field. In other words, the value of the magnetic field is sufficiently low that the ions of the propelling gas are not or substantially not deviated by the magnetic field. This condition allows the ions of the propelling gas to fly through the tube substantially in a straight line, and improves the thrust. Defining the ion cyclotron frequency as
f_{ICR}=q·Bₘₐₓ/2πM

the ion are defined as unmagnetized if the ion cyclotron frequency is much smaller than the ion collision frequency (or the ion Hall parameter, which is their ratio, is lower than 1)
f_{ICR}<<f_{ion-collision}
where q is the electric charge and M is the mass of the ions and Bₘₐₓ the maximum value of the magnetic field. In this constraint, f_{ICR} is the ion cyclotron resonance frequency, and is the frequency at which the ions gyrates around magnetic field lines; the constraint is representative of the fact that the gyration time in the chamber is so long, as compared to the collision period, that the movement of the ions is virtually not changed due to the magnetic field. f_{ion-collision} is defined, as known per se, as
f_{ion-collision}=N·σ·V_{TH}
where N is the volume density of electrons, σ is the electron-ion collision cross section and V_{TH} is the electron thermal speed. The thermal speed can be expressed as

$${V}_{TH} = \sqrt{\frac{kT}{{m}_{e}}}$$

where k is the microscopic Boltzmann constant, T the temperature and m_{c} the electron mass. f_{ion-collision} is representative of the number of collisions that one ion has per second in a cloud of electrons having the density N and the temperature T.

Preferably, one would select the maximum value of the magnetic field so that
f_{ICR}<f_{ion-collision}/2
or even
f_{ICR}<f_{ion-collision}/10
Thus, the ion cyclotron resonance period in the thruster 1 is at least twice longer than the collision period of the ions in the chamber, or in the thruster 1.

This is still possible, while have a sufficient confinement of the gas within the ionization volume of the thruster 1, as evidenced by the numerical example given below. The fact that the ions are mostly insensitive to the magnetic field first helps in focusing the ions and electrons beam the output of the thruster 1, thus increasing the throughput. In addition, this avoids that the ions remained attached to magnetic field lines after they leave the thruster 1; this ensures to produce net thrust.

The thruster 1 further comprises an electromagnetic field generator, which generates an electromagnetic field in the chamber 6. In the example of FIG. 1, the electromagnetic field generator comprises a first resonant cavity 16 and a second resonant cavity 18, respectively located near the coils 12 and 14. The first resonant cavity 16 is adapted to generate an oscillating electromagnetic field in the cavity, between the two maxima of the magnetic field, or at least on the side of the maximum Bₘₐₓ₂ containing the injector, i.e. upstream. The oscillating field is ionizing field, with a frequency f_{E1} in the microwave range, that is between 900 MHz and 80 GHz. The frequency of the electromagnetic field is preferably adapted to the local value of the magnetic field, so that an important or substantial part of the ionizing is due to the electron cyclotron resonance. Specifically, for a given value Bᵣₑₛ of the magnetic field, the electron cyclotron resonance frequency f_{ECR} is given by formula:
f_{ECR}=eBᵣₑₛ/2πm
with e the electric charge and m the mass of the electron. This value of the frequency of the electromagnetic field is adapted to maximize ionization of the propelling gas by electron cyclotron resonance. It is preferable that the value of the frequency of the electromagnetic field f_{E1} is equal to the ECR frequency computed where the applied electromagnetic field is maximum. Of course, this is nothing but an approximation, since the intensity of the magnetic field varies along the axis and since the electromagnetic field is applied locally and not on a single point.

One may also select a value of the frequency which is not precisely equal to this preferred value; a range of ±10% relative to the ECR frequency is preferred. A range of 5% gives better results. It is also preferred that at least 50% of the propelling gas is ionized while traversing the ionization volume or chamber. Such an amount of ionized gas is only made possible by using ECR for ionization; if the frequency of the electromagnetic field varies beyond the range of +10% given above, the degree of ionization of the propelling gas is likely to drop well below the preferred value of 50%.

The direction of the electric component of the electromagnetic field in the ionization volume is preferably perpendicular to the direction of the magnetic field; in any location, the angle between the local magnetic field and the local oscillating electric component of the electromagnetic field is preferably between 60 and 90°, preferably between 75 and 90°. This is adapted to optimize ionization by ECR. In the example of FIG. 1, the electric component of the electromagnetic field is orthoradial or radial: it is contained in a plane perpendicular to the longitudinal axis and is orthogonal to a straight line of this plane passing through the axis; this may simply be obtained by selecting the resonance mode within the resonant cavity. In the example of FIG. 1, the electromagnetic field resonates in the mode TE₁₁₁. An orthoradial field also has the advantage of improving confinement of the plasma in the ionizing volume and limiting contact with the wall of the chamber. The direction of the electric component of the electromagnetic field may vary with respect to this preferred orthoradial direction; preferably, the angle between the electromagnetic field and the orthoradial direction is less than 45°, more preferably less than 20°.

In the acceleration volume, the frequency of the electromagnetic field is also preferably selected to be near or equal to the ECR frequency. This will allow the intensity of the magnetized ponderomotive force to be accelerating on both sides of the Electromagnetic field maximum, as shown in the second equation given above. Again, the frequency of the electromagnetic force need not be exactly identical to the ECR frequency. The same ranges as above apply, for the frequency and for the angles between the magnetic and electromagnetic fields. One should note at this stage that the frequency of the electromagnetic field used for ionization and acceleration may be identical: this simplifies the electromagnetic field generator, since the same microwave generator may be used for driving both resonant cavities.

Again, it is preferred that the electric component of the electromagnetic field be in the purely radial or orthoradial, so as to maximize the magnetized ponderomotive force. In addition, an orthoradial electric component of electromagnetic field will focus the plasma beam at the output of the thruster 1. The angle between the electric component of the electromagnetic field and the radial or orthoradial direction is again preferably less than 45° or even better, less than 20°.

FIG. 2 is a diagram of the intensity of magnetic and electromagnetic fields along the axis of the thruster 1 of FIG. 1; the intensity of the magnetic field and of the electromagnetic field is plotted on the vertical axis. The position along the axis of the thruster 1 is plotted on the horizontal axis. As discussed above, the intensity of the magnetic field—which is mostly parallel to the axis of the thruster 1—has two maxima. The intensity of the electric component of the electromagnetic field has a first maximum Eₘₐₓ₁ located in the middle plane of the first resonant cavity and a second maximum Eₘₐₓ₂ located at the middle plane of the second resonant cavity. The value of the intensity of first maximum is selected together with the mass flow rate within the ionization chamber. The value of the second maximum may be adapted to the Iₛₚ needed at the output of the thruster 1. In the example of FIG. 2, the frequency of the first and second maxima of the electromagnetic field are equal: indeed, the resonant cavities are identical and are driven by the same microwave generator. In the example of FIG. 2, the origin along the axis of the thruster 1 is at the nozzle of the injector.

The following values exemplify the invention. The flow of gas is 6 mg/s, the total microwave power is approximately 1550 W which correspond to ˜350 W for ionisation and ˜1200 W for acceleration for a thrust of about 120 mN. The microwave frequency is around 3 GHz. The magnetic field could then have an intensity with a maximum of about 180 mT and a minimum of ˜57 mT. FIG. 2 also shows the value Bᵣₑₛ of the magnetic field, at the location where the resonant cavities are located. As discussed above, the frequency of the electromagnetic field is preferably equal to the relevant ECR frequency eBᵣₑₛ/2πm.

The following numerical values are exemplary of a thruster 1 providing an ejection speed above 20 km/s and a density of thrust higher than 100 N/m². The tube is a tube of BN, having an internal diameter of 40 mm, an external diameter of 48 mm and a length of 260 mm. The injector is providing Xe, at a speed of 130 m/s when entering the tube, and with a mass flow rate of ˜6 mg/s.

The first maximum of magnetic field Bₘₐₓ₁ is located at X_{B1}=20 mm from the nozzle of the injector; the intensity Bₘₐₓ₁ of the magnetic field is ˜180 mT. The first resonant cavity for the electromagnetic field is located at X_{E1}=125 mm from the nozzle of the injector; the intensity E₁ of the magnetic field is ˜41000 V/m. The second maximum of magnetic field Bₘₐₓ₂ is located at x_{B2}=170 mm from the nozzle of the injector; the intensity Bₘₐₓ₂ of this magnetic field is ˜180 mT. The second resonant cavity for the electromagnetic field is located at x_{E2}=205 mm from the nozzle of the injector; the intensity E₂ of the magnetic field is ˜77000 V/m.
About 90% of the gas passing into the acceleration volume (x>x_{B2}) is ionized.
f_{ICR} is 15.9 MHz, since q=e and M=130 amu. Thus, ion hall parameter is 0.2, so that the ions are mostly insensitive to the magnetic field.

These values are exemplary. They demonstrate that the thruster 1 of the invention makes it possible to provide at the same time an ejection speed higher than 15 km/s and a density of thrust higher than 100 N/m². In terms of process, the thruster 1 of FIG. 1 operates as follows. The gas is injected within a chamber. It is then submitted to a first magnetic field and a first electromagnetic field, and is therefore at least partly ionized. The partly ionized gas then passes beyond the peak value of magnetic field. It is then submitted to a second magnetic field and a second electromagnetic field which accelerate it due to the magnetized ponderomotive force. Ionization and acceleration are separate and occur subsequently and are independently controllable.

Yet, the thruster defined here relies on ECR for ionization and in the example of FIG. 1, as exposed above, the thruster also relies on coils for generating the desired magnetic field. Even though ECR is a very good method to ionize gases, it may also be difficult to start such discharge. It may also be difficult to realize the impedance matching. Moreover, the use of coils to generate the axial magnetic field is power consuming. Furthermore, coils produce a magnetic field outside of the thruster which can notably cause interference to other devices or even damage them. Besides, unless coils are made of supraconducting materials, they produce heat. Thus they have a negative impact on the energetic efficiency of the thruster and on the overall system mass as they demand an additional heat control system.

Thus, there is a need for a thruster having a good ejection speed and versatility. There is also a need for a thruster which could be easily manufactured. Moreover, there is a need for a thruster even more robust, easier to use, lighter than the prior art. There is also a need for a thruster with less heating issues and resistant to failures. This defines a device accelerating both particles to high speed by applications of a directed body force.

The invention therefore provides, in one embodiment a thruster, having
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis, and
obstruction means, located downstream of the injector and upstream of the main chamber, adapted to obstruct partly the main chamber.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis,

wherein the injected ionizable gas is gas surrounding the thruster.

The thruster may also present one or more of the following features:
the injector comprises at least a compression chamber;
the injector comprises at least an expansion chamber.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis, wherein the injector is adapted to inject ionizable gas at the location of the ionizer.

The thruster may also present one or more of the following features:
the injector is adapted to inject ionizable gas in the main chamber through at least a slot.
the injector is adapted to inject ionizable gas in the main chamber through at least a hole.
the injector is adapted to inject ionizable gas in the main chamber at least at one location along the main chamber.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field at least downstream of said ionizer along the direction of thrust on said axis;

wherein the first magnetic field generator is coil less.

The thruster may also present one or more of the following features:
the thruster comprises a first magnetic circuit made of materials with magnetic permittivity greater than the vacuum permittivity and adapted to generate a magnetic field substantially parallel to the axis of the main chamber.
the magnetic field generator comprises at least one magnet.
the magnetic field generator comprises at least one electromagnet.
the thruster comprises at least a second magnetic field generator adapted to generate a second magnetic field and to create a magnetic bottle effect along the axis upstream of the magnetized ponderomotive accelerating field.
the second magnetic field generator comprises at least a coil.
the second magnetic field generator comprises at least a substantially axially polarized magnet
the second magnetic field generator comprises at least a substantially axially polarized electromagnet.
the thruster comprises a third magnetic field generator adapted to generate a third magnetic field, said third magnetic field having at least a third maximum along the axis, said third magnetic field generator at least overlapping the magnetized ponderomotive accelerating field.
the first magnetic field generator and third magnetic field generator have a first common compound.
the first common compound comprises at least a magnet.
the thruster comprises a fourth magnetic field generator adapted to generate a fourth magnetic field, said fourth magnetic field having at least a fourth maximum along the axis, said fourth magnetic field generator being downstream of the third magnetic field generator.
the fourth magnetic field generator and third magnetic field generator have a second common compound.
the second common compound comprises at least a magnet.
the second common compound comprises at least an electromagnet.

The invention also provides, in another embodiment, a thruster having
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis, and
a fifth magnetic field generator adapted to vary the direction of the magnetic field within the magnetized ponderomotive accelerating field.
the fifth magnetic field generator comprises at least one electromagnet.
the fifth magnetic field generator comprises at least one magnet.

The invention also provides, in another embodiment, a thruster having
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis, and
a sixth magnetic field generator adapted to confine ionized gas upstream of the magnetized ponderomotive accelerating field.

The invention also provides, in another embodiment, a thruster having
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis, and
securing means adapted to secure at least two compounds of the thruster.

The thruster may also present one or more of the following features:
the securing means comprise at least a grid.
the securing means comprise at least a plate.
the securing means comprise at least a bar.
the securing means comprise at least a web along the axis.

The invention also provides, in another embodiment, a thruster having
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis; and
at least one resonant cavity;
wherein the electromagnetic field generator is adapted to control the mode of the resonant cavity.

The thruster may also present one or more of the following features:
the electromagnetic field generator further comprises a housing adapted to generate stationary electromagnetic waves within the resonant cavity.
the housing is adapted to contain at least partly the resonant cavity.
the thruster comprises solid material means within the resonant cavity, the said solid material means being adapted to control the mode of the resonant cavity.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis;

wherein the ionizer comprises at least one metallic surface, said metallic surface having a work function greater than a first ionization potential of the propellant.

The invention also provides, in another embodiment, a thruster having
a main chamber defining an axis of thrust;
means adapted to provide ionizable propellant within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on the said axis;

wherein the ionizer comprises at least one electron emitter.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on the said axis;

wherein the ionizer comprises at least two electrodes inside the main chamber, the said at least two electrodes having different electric potentials.

The thruster may also present one or more of the following features:
the at least two electrodes comprise a ring anode and two ring cathodes, adapted to be respectively upstream and downstream of the ring anode.
the thruster comprises a seventh magnetic field generator, adapted to generate a seventh magnetic field at least between the at least two electrodes.
the seventh magnetic field generator is adapted to generate a magnetic bottle comprising the at least two electrodes.

The invention also provides, in another embodiment, a thruster having
a main chamber defining an axis of thrust;
an ionizer adapted to provide ionized propellant within the main chamber; and
a first magnetic field generator and an electromagnetic field generator adapted to generate a magnetized ponderomotive accelerating field downstream of said ionizer along the direction of thrust on the said axis; and
cooling means adapted to remove heat from at least one compound of the thruster.

The invention also provides, in another embodiment, a thruster having
a main chamber defining an axis of thrust;
an ionizer adapted to provide ionized propellant within the main chamber; and
a first magnetic field generator and an electromagnetic field generator adapted to generate a magnetized ponderomotive accelerating field downstream of said ionizer along the direction of thrust on the said axis;

wherein the ionizer is adapted to ablate and ionize a solid propellant

The thruster may also present one or more of the following features:
the ionizer comprises at least two electrodes adapted to deliver current pulses along the said solid propellant surface.
the thruster comprises at least one radiation source is adapted to focus on said solid propellant surface.
the thruster comprises at least an electron beam source is adapted to focus on said solid propellant surface.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis;

wherein the ionizer comprises at least one electromagnetic field generator adapted to apply an alternating electromagnetic field within the main chamber.

The thruster may also present one or more of the following features:
the at least one electromagnetic field generator comprises capacitively coupled electrodes.
the at least one electromagnetic field generator comprises an inductively coupled coil.
the thruster comprises a ninth magnetic field generator adapted to generate a ninth static magnetic field where injected gas is ionized.
the thruster comprises a tenth magnetic field generator adapted to generated a tenth magnetic field generator substantially parallel to the axis of the main chamber, and wherein the at least one electromagnetic field generator comprises at least a helicon antenna.
the ionizer comprises at least one electron emitter.

The invention also provides, in another embodiment, a thruster having
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis;

wherein the ionizer comprises at least one radiation source of wavelength smaller than 5 mm, and adapted to focus an electromagnetic beam on a focal spot.

The thruster may also present one or more of the following features:
the ionizer is adapted to focus within the main chamber.
the thruster comprises a tube comprising at least partly the main chamber, and wherein the ionizer is adapted to focus on the wall of the tube.

The invention further provides a system, comprising:
at least one thruster;
at least one microwave power source adapted to supply with power the at least one thruster.
   The system may further be characterized by one of the following features:
the at least one microwave power source is used for microwave communications of a satellite.
the at least one microwave power source is used for data exchange of a satellite.

The invention further provides a system, comprising:
a spacecraft body;
at least one thruster adapted to direct and/or rotate the spacecraft body.

The invention further provides a process for generating thrust, comprising:
injecting a gas within a main chamber;
obstructing partly the main chamber
ionizing at least part of the gas;
subsequently applying to the gas a first magnetic field and an electromagnetic field for accelerating the partly ionized gas due to the magnetized ponderomotive force.

The invention further provides a process, comprising:
injecting gas surrounding a thruster within a main chamber;
ionizing at least part of the gas;
subsequently applying to the gas a first magnetic field and an electromagnetic field for accelerating the partly ionized gas due to the magnetized ponderomotive force.
   The process may further be characterized by one of the following features:
the process comprises a compressing step of the gas surrounding the thruster before the injecting step.
the process comprises an expanding step of the gas surrounding the thruster before the injecting step.

The invention further provides a process, comprising:
injecting gas within a main chamber;
ionizing at least part of the gas;
subsequently applying to the gas a first magnetic field and an electromagnetic field for accelerating the partly ionized gas due to the magnetized ponderomotive force;

wherein the first magnetic field is applied without using a coil.

The process may further be characterized by one of the following features
the process comprises after applying to the gas a first magnetic field and before applying to the gas an accelerating electromagnetic field, a step of applying a second magnetic field for creating a magnetic bottle effect, upstream the accelerating electromagnetic field.

The invention further provides a process, comprising:
injecting gas within a main chamber;
ionizing at least part of the gas;
subsequently applying to the gas a first magnetic field and an electromagnetic field for accelerating the partly ionized gas due to the magnetized ponderomotive force;
subsequently applying to the gas a fifth magnetic field for varying the direction of the upstream first magnetic field.

The invention further provides a process, comprising:
injecting gas within a main chamber;
ionizing at least part of the gas;
subsequently applying to the gas a first magnetic field and an electromagnetic field for accelerating the partly ionized gas due to the magnetized ponderomotive force;
subsequently applying to the gas a sixth magnetic field for confining the ionized gas upstream of the magnetized ponderomotive accelerating field.

The invention further provides a process, comprising:
injecting gas within a main chamber;
ionizing at least part of the gas;
subsequently applying to the gas a first magnetic field and an electromagnetic field for accelerating the partly ionized gas due to the magnetized ponderomotive force;

wherein the ionizing step further comprises a step of applying an alternating electromagnetic field within the main chamber.

The invention further provides a process, comprising:
injecting gas within a main chamber;
ionizing at least part of the gas;
subsequently applying to the gas a first magnetic field and an electromagnetic field for accelerating the partly ionized gas due to the magnetized ponderomotive force;

wherein the ionizing step further comprises a step of applying an alternating electromagnetic field of wavelength smaller than 5 mm within the main chamber, and for focusing a electromagnetic beam on a focal spot.

The invention further provides a process, comprising:
injecting gas within a main chamber;
ionizing at least part of the gas;
subsequently applying to the gas a first magnetic field and an electromagnetic field for accelerating the partly ionized gas due to the magnetized ponderomotive force;

wherein the ionizing step further comprises a step of bombarding the gas with electrons.

### BRIEF DESCRIPTION OF THE DRAWINGS

A thruster embodying the invention will now be described, by way of non-limiting example, and in reference to the accompanying drawings, where:

FIG. 1 is a schematic view in cross-section of a thruster of the prior art;

FIG. 2 is a diagram of the intensity of magnetic and electromagnetic fields along the axis of the thruster of FIG. 1;

FIGS. 3-9 are schematic views in cross-section of a thruster according various embodiments of the invention;

FIG. 10 is a diagram of the intensity of magnetic field along the axis of the thruster of FIG. 9;

FIG. 11 is a schematic view in cross-section of a thruster according to another embodiment of the invention;

FIG. 12 is a diagram of the intensity of magnetic field along the axis of the thruster of FIG. 11;

FIG. 13 is a schematic view in cross-section of a thruster according to another embodiment of the invention;

FIG. 14 is a diagram of the intensity of magnetic field along the axis of the thruster of FIG. 13;

FIG. 15 is a schematic view in cross-section of a thruster according to another embodiment of the invention;

FIG. 16 is a diagram of the intensity of magnetic field along the axis of the thruster of FIG. 15;

FIG. 17 to 20 are schematic views of various embodiments of the thruster, which allow the direction of thrust to be changed;

FIG. 21 is a schematic view of another embodiment of the thruster;

FIG. 22 is a schematic view in cross-section of a thruster according to the thruster of FIG. 21;

FIG. 23 is a diagram of the intensity of magnetic and electromagnetic fields of the thruster of FIG. 21;

FIG. 24 is a schematic view in cross-section of a thruster according to another embodiment of the invention;

FIG. 25 is a schematic view of a thruster according to another embodiment of the invention;

FIG. 26 is a schematic view in cross-section of a thruster according to another embodiment of the invention;

FIGS. 27-39 are schematic views in cross-section of various ionizers 124 of a thruster according to other embodiments of the invention; and

FIG. 40 is a schematic view of a system according to another embodiment of the invention.

### DETAILED DESCRIPTION

First, propellant is defined as the material whose ejection makes thrust. For instance, propellant may be gas. It could also be solid.

FIG. 3 is a schematic view in cross-section of a thruster 1 according to a first embodiment of the invention. The thruster 1 of FIG. 3 comprises obstruction means 50 between the injector 8 and the main chamber 6 adapted to obstruct partly the main chamber 6. In other words, FIG. 3 discloses a thruster 1, having first a main chamber 6 defining an axis 4 of thrust; second an injector 8 adapted to inject ionizable gas within the main chamber 6; third a ionizer 124 adapted to ionize the injected gas within the main chamber 6; fourth a first magnetic field generator 12, 14 and an electromagnetic field generator 18 adapted to generate a magnetized ponderomotive accelerating field downstream of said ionizer 124 along the direction of thrust on said axis 4; and fifth obstruction means 50, located downstream of the injector 8 and upstream of the main chamber 6, adapted to obstruct partly the main chamber 6. This makes injected gas be first reflected by the obstruction means before passing aside the obstruction means go along the main chamber 6. After being reflected, the gas goes back towards downstream of the main chamber because the upstream pressure is higher than the downstream one. This improves uniformity of the flow in the main chamber 6 and limits the gradient of neutral atom density in the main chamber 6, which can be desired if the energetic electrons are also more or less uniformly distributed inside the ionization area. The obstruction means 50 are made of non-conductive materials for allowing magnetic and electromagnetic fields to be produced within the main chamber 6; one may use low permittivity ceramics, quartz, glass or similar materials. Therefore, the magnetic and electromagnetic fields are less perturbed. The shape of the obstruction means 50 is adapted to the plasma flow desired at the output of the thrusters 1. The shape is hence adapted for instance to the shape of the tube 2. In the example of FIG. 3, the obstruction means 50 comprise two compounds obstructing partly the main chamber. The first obstruction means 50 is a disc 51. The second one is a ring diaphragm 49.

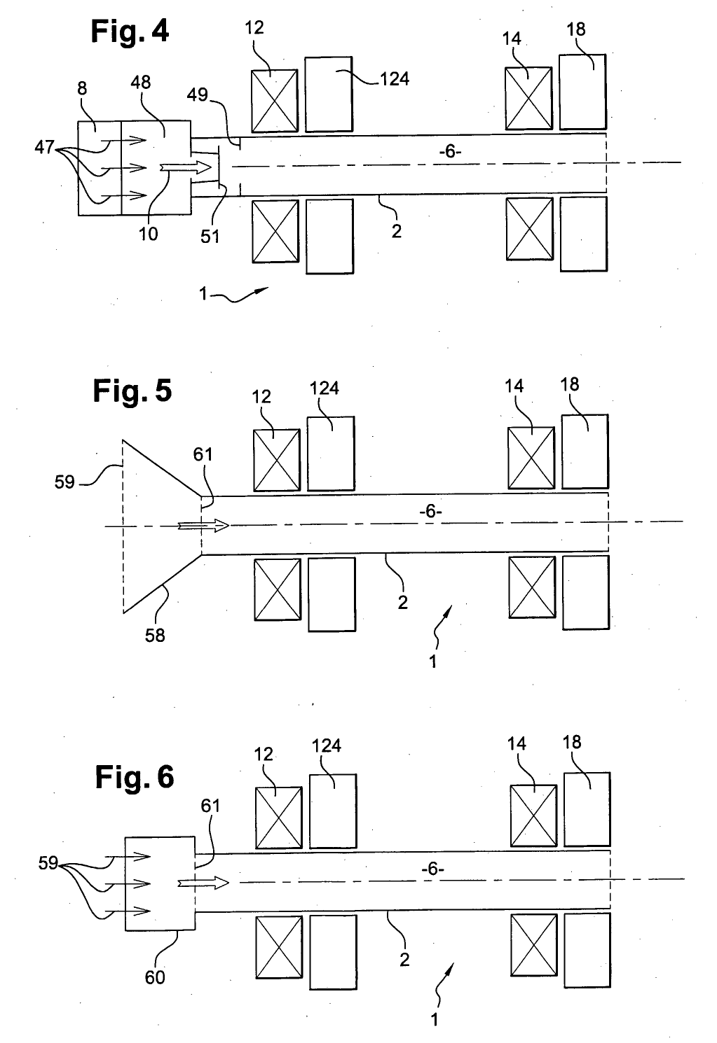

FIG. 4 is a schematic view in cross-section of a thruster 1 according to another embodiment of the invention. The thruster 1 of FIG. 4 comprises a quieting chamber 48. In other words, FIG. 4 discloses a thruster 1, having first a main chamber 6 defining an axis 4 of thrust; second an injector 8 adapted to inject ionizable gas within the main chamber 6; third a ionizer 124 adapted to ionize the injected gas within the main chamber 6; fourth a first magnetic field generator 12, 14 and an electromagnetic field generator 18 adapted to generate a magnetized ponderomotive accelerating field downstream of said ionizer 124 along the direction of thrust on said axis 4; and fifth a quieting chamber 48 located downstream of the injector 8 and upstream of the main chamber 6 wherein the quieting chamber 48 is adapted to receive the ionizable gas. The quieting chamber 48 is located upstream of the main chamber 6. This quieting chamber 48 has the advantage of protecting the injector nozzle against high energy electrons, which may pass beyond the barrier created by the first maximum Bₘₐₓ₁ of magnetic field. Such a quieting chamber 48 will improve uniformity of the flow in the main chamber 6 and limit the gradient of density in the chamber. Such a quieting chamber 48 can be coupled with obstruction means to improve uniformity of the flow in the chamber and limit the gradient of density in the chamber. When the quieting chamber 48 is coupled with the obstruction means 50, the former 48 is located upstream of the latter 50.

FIG. 5 is a schematic view in cross-section of a thruster 1 according to another embodiment of the invention. The thruster 1 of FIG. 5 comprises a compression chamber 58. The compression chamber 58 is an injector 8. Such a compression chamber 58 is adapted to bring propellant to the desired pressure for instance by changing the temperature. Propellant can be also brought to the desired pressure by reducing mechanically the volume of a closed chamber. It is also possible to compress gas in a continuous way: such a compression chamber 58 has upstream communication means 59 and downstream communication means 61; the sum of the surfaces of upstream communication means 59 is greater than the sum of the surfaces of downstream apertures. Thus, such a compression chamber 58 can be substantially convergent-shaped in the stream direction. In the example of FIG. 5, the compression chamber is tapered. This allows to compress gas surrounding the thruster 1, for instance atmospheric gas. In case of a spacecraft which comprises the thruster, the gas surrounding the thruster is gas outside the thruster, i.e. gas outside the spacecraft. This gas is compressed in order to get a desired pressure and density upstream of the main chamber. Such pressure and density being adapted to the operating condition of the thruster, i.e. the desired thrust and the specific impulse. Thus, there is no need to store propellant. Such a compression chamber can be used for upper atmospheric gas in extremely rarefied condition or even to use interplanetary plasma, also known as solar wind. At lower altitude, the pressure of the atmospheric gas is greater than needed for the thruster 1.

FIG. 6 is a schematic view in cross-section of a thruster 1 according to another embodiment of the invention. The thruster 1 of FIG. 6 comprises an expansion chamber. The expansion chamber 60 is an injector 8. Such a chamber has upstream communication means 59 and downstream communication means 61. The sum of the surfaces of downstream communication means 61 is greater than the sum of the surfaces of upstream communication means 59. Thus, such an expansion chamber 60 is substantially divergent-shaped in the stream direction. This allows to expand gas surrounding the thruster 1, i.e. atmospheric gas, in order to get desired pressure and density upstream of the main chamber 6. Thus, this prevents from storing propellant. Such an expansion chamber can be used for atmospheric gas where the pressure and density of the atmospheric gas is greater than needed. The upstream communication means 59 may be apertures in the expansion chamber 60 wall. Upstream communication means 59 can be controlled by valves.

In other words, FIGS. 5 and 6 disclose a thruster 1, having first a main chamber 6 defining an axis 4 of thrust; second an injector 8 adapted to inject ionizable gas within the main chamber 6; third a ionizer 124 adapted to ionize the injected gas within the main chamber 6; and fourth a first magnetic field generator 12, 14 and an electromagnetic field generator 18 adapted to generate a magnetized ponderomotive accelerating field downstream of said ionizer 124 along the direction of thrust on said axis 4; wherein the injected ionizable gas is gas surrounding the thruster 1. Once again, this suppresses or reduces the necessity of storing propellant.

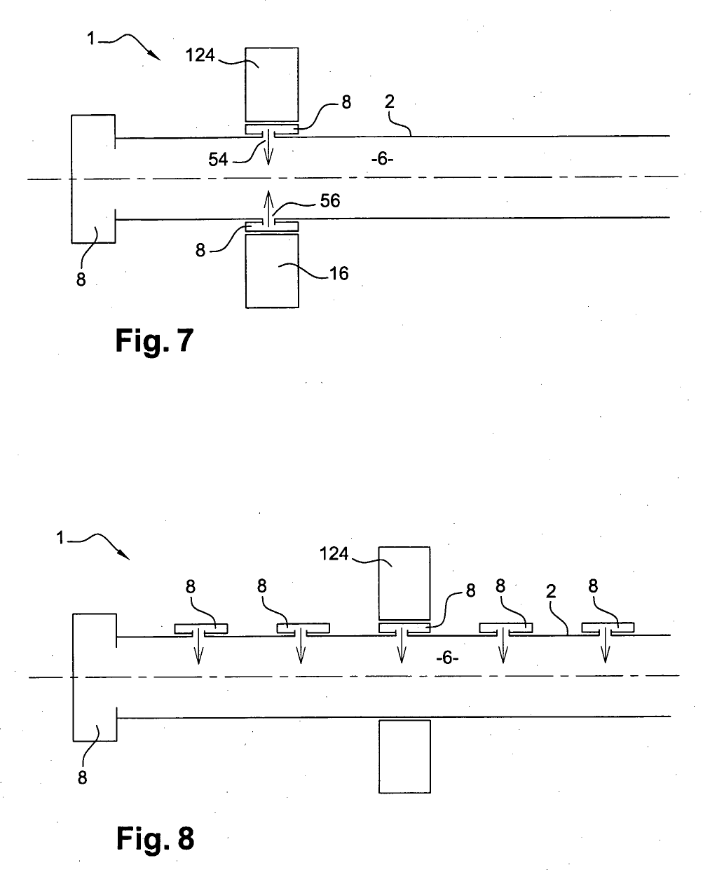

FIG. 7 is a schematic view in cross-section of a thruster 1 according to another embodiment of the invention. The thruster 1 of FIG. 7 comprises an injector 8 adapted to inject ionizable gas directly within the ionization area of the main chamber 6. In other words, FIG. 7 discloses a thruster 1, having first a main chamber 6 defining an axis 4 of thrust; second an injector 8 adapted to inject ionizable gas within the main chamber 6; third a ionizer 124 adapted to ionize the injected gas within the main chamber 6; and fourth a first magnetic field generator 12, 14 and an electromagnetic field generator, 18 adapted to generate a magnetized ponderomotive accelerating field downstream of said ionizer 124 along the direction of thrust on said axis 4; wherein the injector 8 is adapted to inject ionizable gas where the ionizing field is applied in the main chamber 6. This has the advantage of injecting ionizable gas where the density of energized electrons is the greatest in the main chamber 6. Thus, the ionizing collision frequency is greater. This injection may be done through a slot 54 in the wall of the tube 2 of the main chamber 6. This improves the uniformity of the injected gas since the stream of the injected gas has the same symmetry as the one of the slot. The injection may also be done through at least one hole 56 in the wall of the tube 2 of the main chamber 6. This also improves ionization efficiency since the pressure stream of the injected gas make it reach quicker the center of the area with high density of energized electrons inside the main chamber 6. In the example of FIG. 7, gas is injected through a slot 54 and a hole 56 within the ionization area of the main chamber 6. By increasing neutral atom density at the same location where the energized electrons distribution is maximum, when the energized electrons are not distributed uniformly inside the ionization are, the ionization efficiency is improved. Hence, the overall thruster energetic efficiency is improved.

FIG. 8 is a schematic view in cross-section of a thruster 1 according to another embodiment of the invention. The thruster 1 of FIG. 8 comprises an injector 8 adapted to inject ionizable gas in the main chamber 6 along the main chamber 6. This limits the effects of an upstream injection on axial uniformity. Thus, this improves gas uniformity along the main chamber 6. In the example of FIG. 8, gas is injected through regularly spaced apertures in the wall of the tube 2.

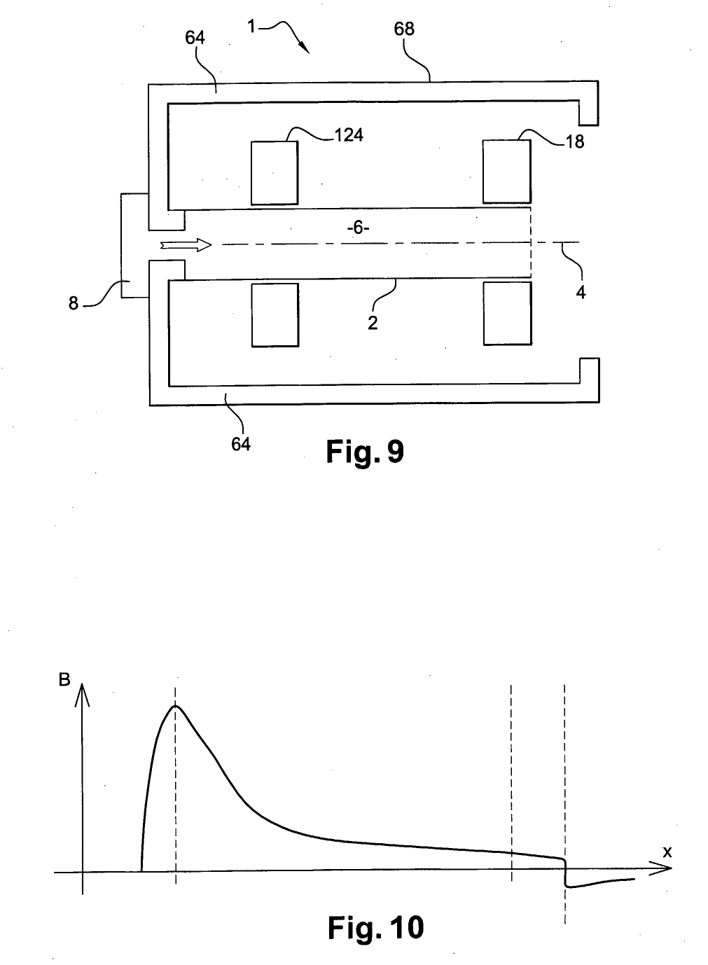

FIG. 9 is a schematic view in cross-section of a thruster 1 according to another embodiment of the invention. FIG. 10 is a diagram of the intensity of magnetic field along the axis of the thruster 1 of FIG. 9. The thruster 1 of FIG. 9 comprises first a main chamber 6 defining an axis 4 of thrust. It also comprises an injector 8 adapted to inject ionizable gas within the main chamber 6. Moreover, it comprises a first magnetic field generator 12 adapted to generate a magnetic field, said magnetic field having at least a first maximum along the axis 4, said magnetic field being substantially axial and decreasing along the axis 4. Furthermore, it comprises an ionizer 124 adapted to generate a ionizing area in the main chamber 6, downstream of said first maximum, and a magnetized ponderomotive accelerating field downstream of said microwave ionizing field. In other words, FIG. 9 discloses a thruster 1, having first a main chamber 6 defining an axis 4 of thrust; second an injector 8 adapted to inject ionizable gas within the main chamber 6; third a ionizer 124 adapted to ionize the injected gas within the main chamber 6; and fourth a first magnetic field generator 12, 14 and an electromagnetic field generator 18 adapted to generate a magnetized ponderomotive accelerating field downstream of said ionizer 124 along the direction of thrust on said axis 4; wherein the first magnetic field generator 12, 14 is coil less. This allows the use of ponderomotive force for the thruster 1 using a magnetic field which substantially decreases along the axis. This allows to use magnets and electromagnets instead of coils for the realization of the magnetic field generator 12, and hence to avoid the mass and heat drawbacks of coils.

In this embodiment, the thrusters 1 may comprise a magnetic circuit 68 made of materials with magnetic permeability greater than the vacuum one. This allows to apply efficiently the magnetic field at the location where useful. Moreover, it prevents from having large fringing magnetic field outside the thruster which might disturb other spacecraft subsystem. This also makes electromagnet use less power for producing a similar magnetic field at location where desired. The magnetic circuit 68 is adapted to generate a magnetic field substantially parallel to the axis of the main chamber 6. This has the advantage to create and to improve the ponderomotive force. The magnetic field of this circuit 68 is downstream divergent. This allows the downstream plasma to detach more easily from the magnetic field. Thus, this reduces the plasma beam divergence and hence improves the thrust. The magnetic circuit may be non-continuous. That is the magnetic circuit may comprise regions or elements which have a relative magnetic permeability equal to the vacuum one. The shape of the magnetic circuit is adapted to the plasma flow needed at the output of the thrusters. The shape is hence adapted for instance to the shape of the tube 2. Another advantage of this magnetic circuit 68 is the compounds that may be used.

The magnetic field generator 12, 14 may comprise at least one magnet 64. A magnet 64 has notably the advantage over a coil, or an electromagnet not to be dependant on any power source and not to heat. The magnetic field generator 12, 14 may also comprise at least one electromagnet 64. An electromagnet 66 has notably the advantage over coils to consume less electrical energy and to heat less. An electromagnet 66 has the advantage over a magnet 64 to be controllable.

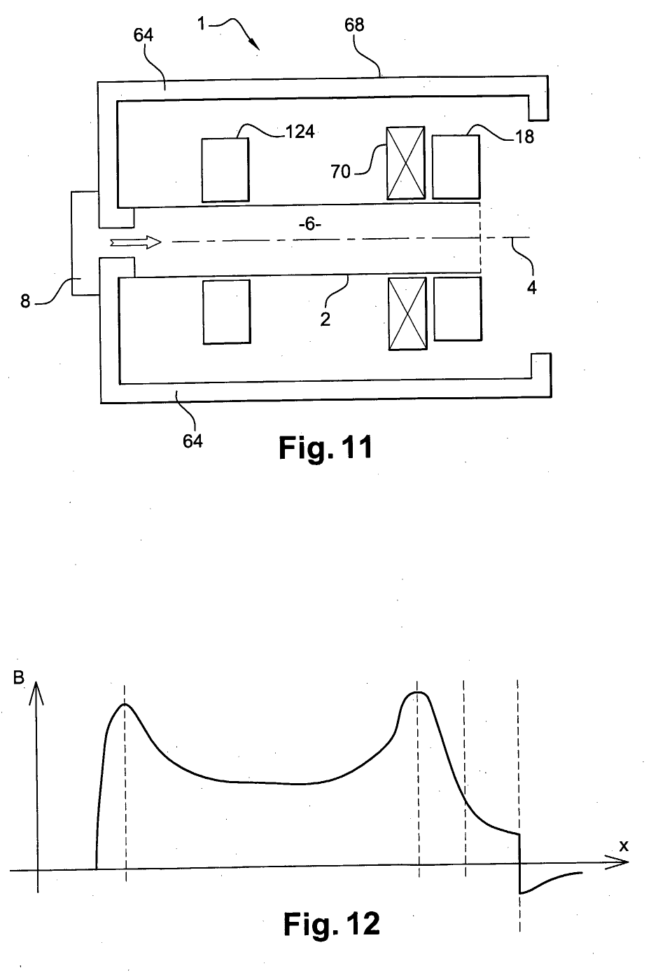

FIG. 11 is a schematic view in cross-section of a thruster according to another embodiment of the invention. FIG. 12 is a diagram of the intensity of magnetic field along the axis of the thruster of figure. The thruster of FIG. 11 comprises at least a second magnetic generator 70 adapted to generate a magnetic field, said magnetic field being superimposed with the first magnetic field produces at least a second maximum of magnetic field intensity along the axis 4, said second maximum being downstream of the said first maximum and upstream of the magnetized ponderomotive accelerating field. In other words, FIG. 11 discloses thruster 1 further comprising at least a second magnetic field generator 70 adapted to generate a magnetic field and to create a magnetic bottle effect along the axis 4 upstream of the magnetized ponderomotive accelerating field. Indeed, such a magnetic field generator allows to create the magnetic bottle effect. Indeed, a second magnetic field maximum is created downstream of the first magnetic field maximum and upstream of the magnetized ponderomotive accelerating field. In other words, the second magnetic field generator 70 generates a field along the axis 4, which has the same direction as the field generated by the first magnetic field generator 12, 14. Thus, this allows to increase the total magnetic field intensity on the axis 4, downstream of the first magnetic field maximum and upstream of the magnetized ponderomotive accelerating field, in adding the second magnetic field generator 70 at the plumb of the magnetic field second maximum. Hence, the main chamber 6 is not limited by the wall of the tube 2 but by the magnetic field lines. This increases the overall thruster energetic efficiency by limiting the flux of electrons and ions colliding with the actual material wall of the chamber. This second magnetic field generator 70 may be realized using a coil, as in the example of FIG. 10, its energy needs will be lower than when using a structure using only coils.

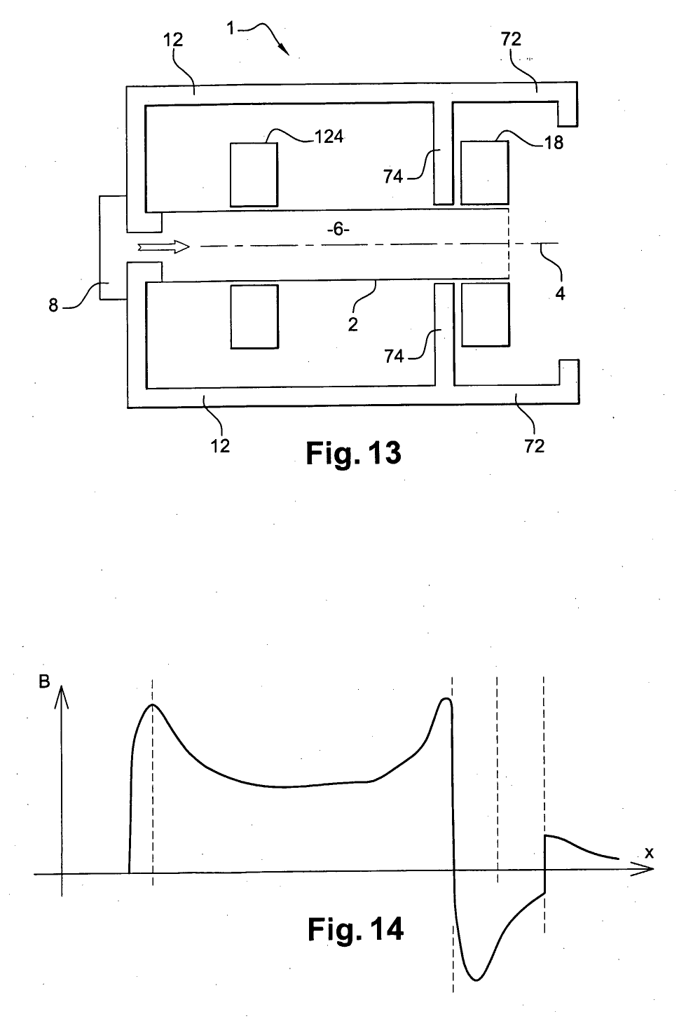

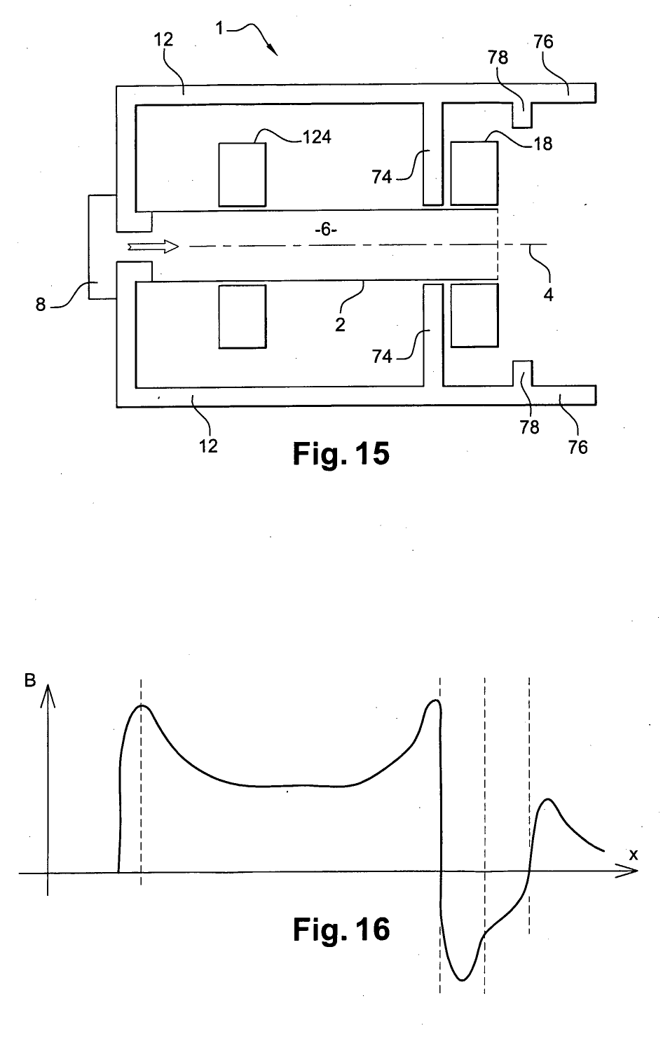

FIG. 13 is a schematic view in cross-section of a thruster according to another embodiment of the invention. FIG. 14 is a diagram of the intensity of magnetic field along the axis of the thruster of FIG. 13. The thruster of FIG. 13 is such that the first magnetic circuit 68 is closed downstream of the microwave ionizing field in the main chamber 6 and upstream of the magnetized ponderomotive accelerating field. It also comprises a third magnetic field generator 72 adapted to generate a magnetic field, said magnetic field having at least a third maximum along the axis 4, said third magnetic field generator 72 being downstream of the first magnetic field generator 12, 14 and at least overlapping a magnetized ponderomotive accelerating field. Along the axis, the first and third magnetic fields generated by the first 12, 14 and third 72 magnetic field generators may be of same or opposite polarity. This arrangement may be lighter and requires much less electrical power than when using only one magnetic field generator 12, 14 and a second magnetic field generator 70 comprising a coil. It creates the bottle effect. It also creates a cusp, i.e. a region where there is no magnetic field, upstream of the third magnetic field generator 72. It is therefore advantageous that, when the axis of the thruster does not pass through the created cusp; the wall of the tube 2 be near the borders of this magnetic field free region, but avoids passing through this zone. The first 12, 14 and third 72 magnetic field generators may have a first common compound 74. If there is a common compound 74, this one might be located at the plumb of the cusp. When the axis of the thruster passes through the magnetic field cusp; even if the flow of plasma substantially follows the magnetic field lines, plasma is repelled from region where the gradient of magnetic field intensity is too important. This is the mirror effect. It is due to a great gradient of the magnetic field proximate the common compound 74 of both first 12, 14 and third 70 magnetic field generators. Since the plasma is repelled from the tube walls, it is confined along the axis, which is sought. The first common compound 74 may comprise a magnet, an electromagnet, or a coil. This embodiment presents the same advantage as the advantages of using a magnet, an electromagnet exposed above. It allows also to have a magnetic bottle along the thruster axis 4 upstream of the accelerating field. FIG. 15 is a schematic view in cross-section of a thruster according to another embodiment of the invention. FIG. 16 is a diagram of the intensity of magnetic field along the axis of the thruster of FIG. 15. The thruster of FIG. 15 comprises a fourth magnetic field generator 76 adapted to generate a magnetic field, said magnetic field having at least a third maximum along the axis 4, said fourth magnetic field generator 76 being downstream of the third magnetic field generator 72. Along the axis, the fourth and third magnetic fields generated by the fourth 76 and third 72 magnetic field generators may be of opposite polarities. When both the fourth and third magnetic fields generated by the fourth 76 and third 72 magnetic field generators are of opposite polarities, it creates a cusp, the axis 4 of the thruster 1 passing through the created cusp. This allows the plasma to escape more easily from magnetic field. Indeed, this corresponds to enlarge the region downstream of the accelerating region where there is no magnetic field. Thus, the magnetic field gradient is increased in this accelerating region. Therefore, the divergence of the plasma beam might be reduced. There is also a mirror effect between both magnetic field generators 72, 76. In another embodiment, the fourth 76 and third 72 magnetic field generators may have a second common compound 78. This second common compound 78 may comprise a magnet, an electromagnet, or a coil. This embodiment presents the same advantage as the advantage of using a magnet, an electromagnet, or a coil, as exposed above and when the fourth magnetic field generator is somehow controllable, this brings a greater control over the acceleration region and the outlet region which make the thruster more versatile.

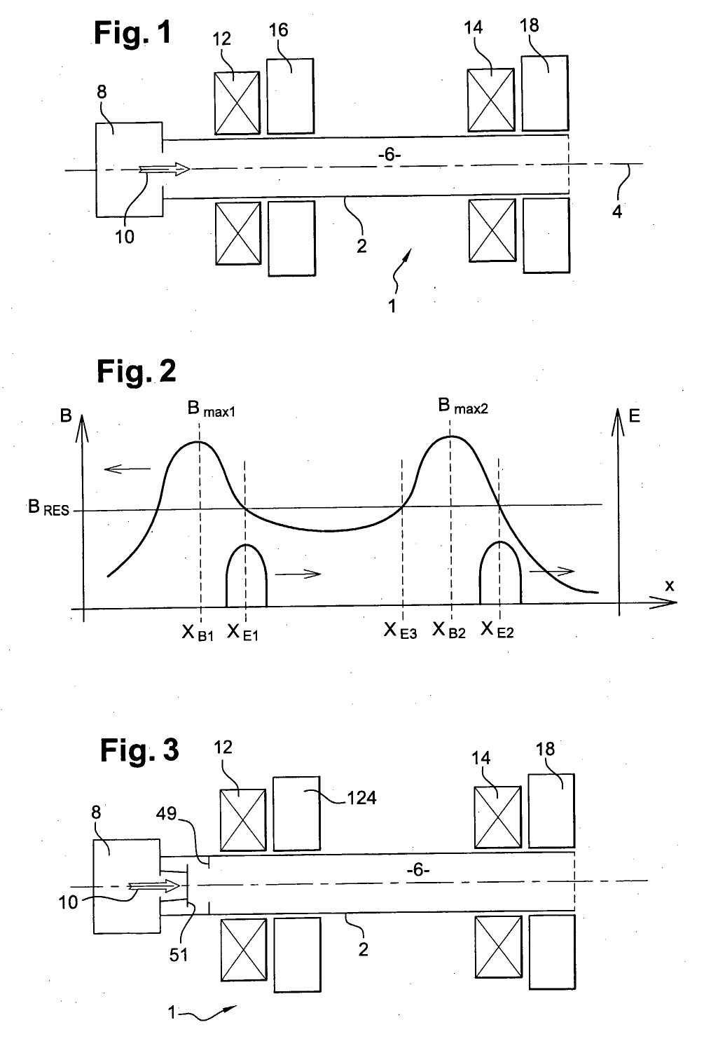

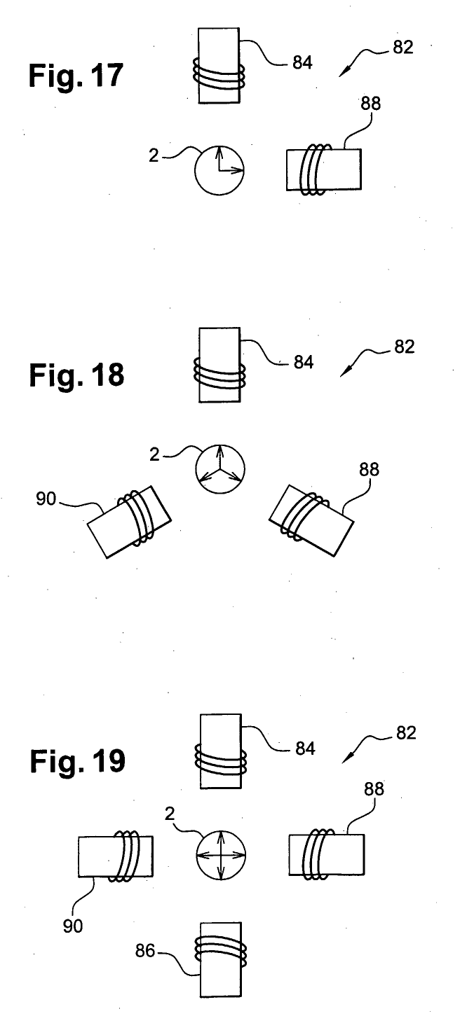

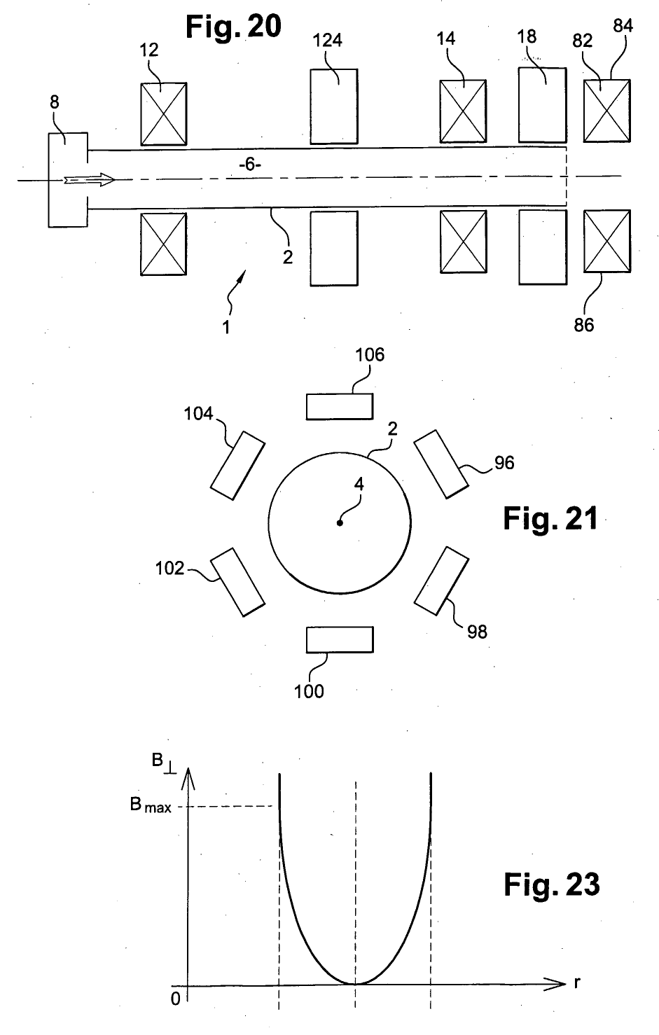

FIGS. 17 to 20 are schematic views of various embodiments of the thruster, which allow the direction of thrust to be changed. This ability to change thrust direction is called thrust vectoring. As discussed above, the ponderomotive force is directed along the lines of the magnetic field. Thus, modifying the direction and the intensity of the magnetic field lines inside and downstream of the accelerating area of the thruster makes it possible to change the direction of thrust. FIG. 20 is a view in cross section of another embodiment of the thruster. The thruster is similar to the one of FIG. 1. The thruster of FIG. 20 comprises a fifth magnetic field generator 82 adapted to modify the magnetic field within and downstream of the accelerating field. Thus, it is possible to vary the direction. In other words, FIG. 20 discloses a thruster 1, having first a main chamber 6 defining an axis 4 of thrust; second an injector 8 adapted to inject ionizable gas within the main chamber 6; third a ionizer 12 adapted to ionize the injected gas within the main chamber 6; and fourth a first magnetic field generator 12, 14 and an electromagnetic field generator 18 adapted to generate a magnetized ponderomotive accelerating field downstream of said ionizer 124 along the direction of thrust on said axis 4; and a fifth magnetic field generator 82 adapted to vary the direction of the magnetic field downstream of the magnetized ponderomotive accelerating field. In the example of FIG. 20, the thruster is provided with a fifth magnetic field generator 82, that comprises in this example four additional direction control electromagnets 84, 86, 88 and 90 located downstream of the magnetized ponderomotive accelerating field. These electromagnets need to be offset with respect to the axis of the thruster, so as to change the direction of the magnetic field downstream of the magnetic field generator which is located at most downstream. Moreover, these electromagnets can also be equidistant from the axis 4 of the main chamber 6. FIG. 19 is a front view showing the four electromagnets 84, 86, 88 and 90 and the tube 2; it further shows the various magnetic fields that may be created by energizing one or several of these electromagnets, which are represented symbolically by arrows within the tube 2. Preferably, the electromagnets generate a magnetic field with a direction contrary to the one created by upstream of magnetic field generator 12 and 14; this further increases the gradient of magnetic field, and therefore the thrust. Furthermore, energizing the electromagnets with a reversible current makes it possible to vary the thrust direction over a broader range and use less electromagnets (2 or 3 instead of 4) but use a more complex power supply. It is also possible to use mere magnets. Yet, they need to be moved about in order to make the downstream magnetic field vary.

FIG. 17 is a front view similar to the one of FIG. 19, but in a thruster having only two additional electromagnets 84, 88. FIG. 18 is a front view similar to the one of FIG. 19, but in a thruster having only three additional electromagnets.

In the examples of FIGS. 17 to 20, the direction control fifth magnetic field generator 82 is located as close as possible to the second cavity, i.e. to the downstream of the magnetized ponderomotive accelerating field, so as to act on the magnetic field in or close to the acceleration volume. It is advantageous that the intensity of the magnetic field in the direction control fifth magnetic field generator 82 be selected so that the magnetic field still decreases substantially continuously downstream of the thruster; this avoid any mirror effect that could locally trap the plasma electrons. The value of magnetic field created by the direction control fifth magnetic field generator 82 is preferably from 5% to 95% of the main field so that it nowhere reverses the direction of the magnetic field within the ponderomotive accelerating field.

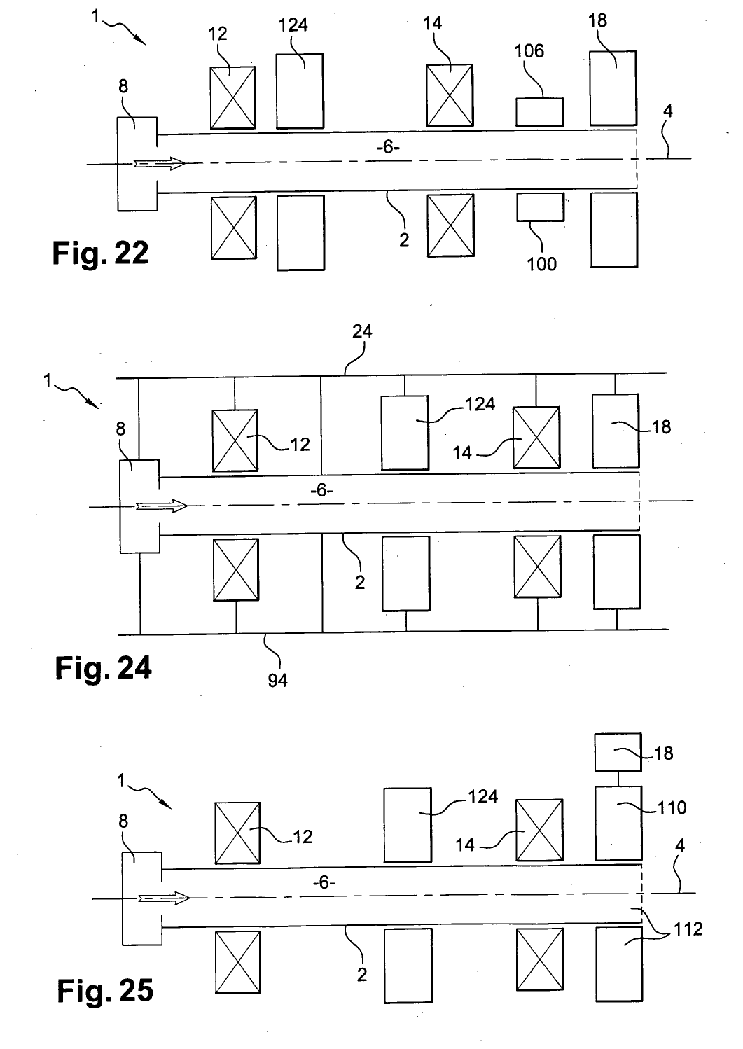

FIG. 21 is a schematic view of another embodiment of the thruster. FIG. 22 is a schematic view in cross-section of a thruster according to the thruster of FIG. 21. FIG. 23 is a diagram of the intensity of magnetic and electromagnetic fields along the axis of the thruster of FIG. 21. FIG. 21 comprises a sixth magnetic field generator 96 adapted to confine the ionized gas in the plane perpendicular to the axis 4. In other words, FIG. 21 discloses a thruster 1, having first a main chamber 6 defining an axis 4 of thrust; second an injector 8 adapted to inject ionizable gas within the main chamber 6; third a ionizer 124 adapted to ionize the injected gas within the main chamber 6; and fourth a first magnetic field generator 12, 14 and an electromagnetic field generator 18 adapted to generate a magnetized ponderomotive accelerating field downstream of said ionizer 124 along the direction of thrust on said axis 4; and a sixth magnetic field generator 96 adapted to confine ionized gas upstream of the magnetized ponderomotive accelerating field. The sixth magnetic field generator 96 is downstream of the first magnetic field generator 12, 14. The sixth magnetic field generator 96 can be downstream of the magnetic field generator 12 and/or upstream of the ionizer 124 and downstream of the ionizer 124 down to the thruster exhaust. Preferably, the sixth magnetic field generator 96 is even more useful over the section comprised downstream of the ionizer 124 and upstream of the generator of the ponderomotive accelerating field 18. This better confines the charged particles before their acceleration. Therefore, the sixth magnetic field generator 96 is at least within of the means creating the bottle effect. This confinement is realised in creating a cusp comprising the axis 4 and its vicinities. The vicinities are bordered by the magnetic field lines of the sixth magnetic field generator 96. This is possible in creating a mirror effect in the plane perpendicular to the axis 4 of the main chamber 6. Therefore, the plasma is repelled towards the axis 4. Thus, it limits energetic loss. It also prevents the wall of the tube from heating. Moreover, it improve the energetic efficiency of the thruster since there is a greater plasma density for a similar ionization energy. This is for instance realised by using a set of a pair plurality of magnetic field generators 96-106. The magnetic axis of each of these generators 96-106 is defined as the straight line between the centres, centres of gravity, of each magnetic poles, or ending cross-section, of each generator. The magnetic axes can be substantially parallel to the local tangent to the wall of the tube 2 and substantially perpendicular to the longitudinal axis 4 of the main chamber 6. In another embodiment, the magnetic axis are perpendicular to the local tangent and to the longitudinal axis 4 of the main chamber 6. The magnetic field generators 96-106 can be arranged so that each pole of a generator 96-106 faces the pole of the neighboured generator 96-106 which has the same polarity. Alternatively, each pole of any generator has the same polarity as the pole of the generator symmetrically opposite of it regarding the axis 4 of the main chamber 6, for example 96 and 102, or 106 and 100 in FIG. 21. The magnetic field generators 96-106 are also arranged so that there are included in at least a cross-section of the tube 2 perpendicular to the axis 4 of the main chamber 6. Preferably, there are at least four magnetic field generators. This prevents from having any possible radial leak of plasma since there is a mirror effect in all the radial directions. Indeed, if there are only two magnetic field generators, there is one direction that is not bordered by converging magnetic field lines, that is by magnetic field lines that could prevent the plasma from leaking in the plane perpendicular to the axis 4 of the main chamber 6. This embodiment may be realised with magnets, electromagnets or coils.

FIG. 24 is a schematic view in cross-section of a thruster according to another embodiment of the invention. FIG. 24 comprises securing means 94 adapted to secure at least two compounds of the thruster. In other words, FIG. 24 discloses a thruster 1, having first a main chamber 6 defining an axis 4 of thrust; second an injector 8 adapted to inject ionizable gas within the main chamber 6; third a ionizer 124 adapted to ionize the injected gas within the main chamber 6; and fourth a first magnetic field generator 12, 14 and an electromagnetic field generator, 18 adapted to generate a magnetized ponderomotive accelerating field downstream of said ionizer 124 along the direction of thrust on said axis 4; and securing means 94 adapted to secure at least two compounds of the thruster 1. This allows to set distances between compounds of the thruster. Compounds of the thruster comprise any device used in an embodiment. In the example of FIG. 24, the compounds are the injector 8, first magnetic field generator 12, 14, the tube 2, the electromagnetic field generators, 18. Hence, this prevents the compounds to move. Thus, it prevents compounds from damages. Distances are also controlled. This can be realized in gluing or molding the compounds of the thruster in a castable material, i.e. a partially fluid material which can harden to solid, such as a ceramic, glass or a resin. Yet, this material is heavy, may heat, and prevents from any future movement of the compounds—for instance to access a compound. Preferably, securing means are adapted to prevent movement of compounds even when the compounds are exposed to a force greater than one giga Newton. Notably, it prevents movement in case of accelerations, vibrations and shocks of intensity and duration similar to the one undergone by any spacecraft part during orbital launch onboard a rocket. The securing means can be a grid, a plate, a bar, or a web along the axis 4. The selection among these different securing means 94 depends on a compromise between their weights, solidities, or shape according to the thruster 1 Securing means can have a shape adapted to the thruster. In the example of FIG. 24, the securing means are two bars.

A mode is defined as the spatial distribution of the intensity and phase of the electromagnetic energy field within a resonant cavity 112. In the accelerating region, it is advantageous to select a mode such that there is a maximum of electromagnetic energy within the main chamber 6, or even within the tube 2. This allows to increase the ponderomotive force. Yet, in the resonant cavity 112, the electrical permittivity of the plasma may transform the modes within the resonant cavity 112, and/or may make their frequency vary. Therefore, in another embodiment of the invention, the thruster 1 comprises first a main chamber 6 defining an axis 4 of thrust; second an injector 8 adapted to inject ionizable gas within the main chamber 6; third a ionizer 124 adapted to ionize the injected gas within the main chamber 6; and fourth a first magnetic field generator 12, 14 and an electromagnetic field generator 18 adapted to generate a magnetized ponderomotive accelerating field downstream of said ionizer 124 along the direction of thrust on said axis 4; and at least one resonant cavity 112; wherein the electromagnetic field generator 18 is adapted to control the mode of the resonant cavity 112.

FIG. 25 is a schematic view in cross-section of a thruster according to another embodiment of the invention. The electromagnetic field generator 18 of FIG. 25 further comprises a housing 110 adapted to generate stationary electromagnetic waves in the resonant cavity 112. A housing 110 is defined as a system adapted to provide the resonant cavity 112 with microwave power through more than one connection means and with a defined phase relation between them. This housing 110 guides electromagnetic waves to the resonant cavity. 112 Therefore, the creation of stationary waves in the housing 110 provides stationary electromagnetic waves in the resonant cavity 112. Then, stationary electromagnetic waves allow to control the modes of the resonant cavity 112. Stationary waves can be selected to get electromagnetic energy maxima where desired, for instance along the axis where the plasma is confined or where the main chamber 6 passes.

It is advantageous to have a housing 110 sufficiently large in at least one dimension to obtain stationary electromagnetic waves. Yet, this increases the weight of the thruster 1. In the example of FIG. 24, the housing 110 is adapted to contain the resonant cavity 112. This limits the modification of the modes pattern by plasma or/and the variation of the frequency of the modes in the resonant cavity 112. Indeed, the plasma is contained within the resonant cavity 112 and in no other area of the housing. Therefore, the plasma can not modify the modes within the housing outside of the resonant cavity 112, and/or can not either may make their frequency vary. Reciprocally, the stationary waves inside the housing outside of the cavity prevent the mode inside the cavity from changing. In other words, as the plasma affects only the part of the complete standing wave pattern contained in the cavity and not in the part contained in the rest of the housing, the overall mode is more robust. Thus, the mode is less modified, i.e. a given modification of the mode requires more energy. Thus, the mode is fixed from outside the resonant cavity. The housing 110 may be connected to the electromagnetic field generator 18 by various connection means such as a magnetic loop, a slot, or an electric dipole antenna. The choice of the connection means and of the place of connection defines the existing modes.

When the mode is such that there are several electromagnetic energy maxima or a maximum outside the axis 4 of the thruster, the shape and localisation of the tube 2 and of the main chamber 6 may be adapted to the radial localisation of the maxima. For instance, the tube can be divided in several secondary tubes. This allows to use the modes with a minimum along the axis 4. Thus, this optimizes the exhaust surface-to-foot-print ratio of the thruster, the foot-print being the overall cross section surface required to mount the thruster.

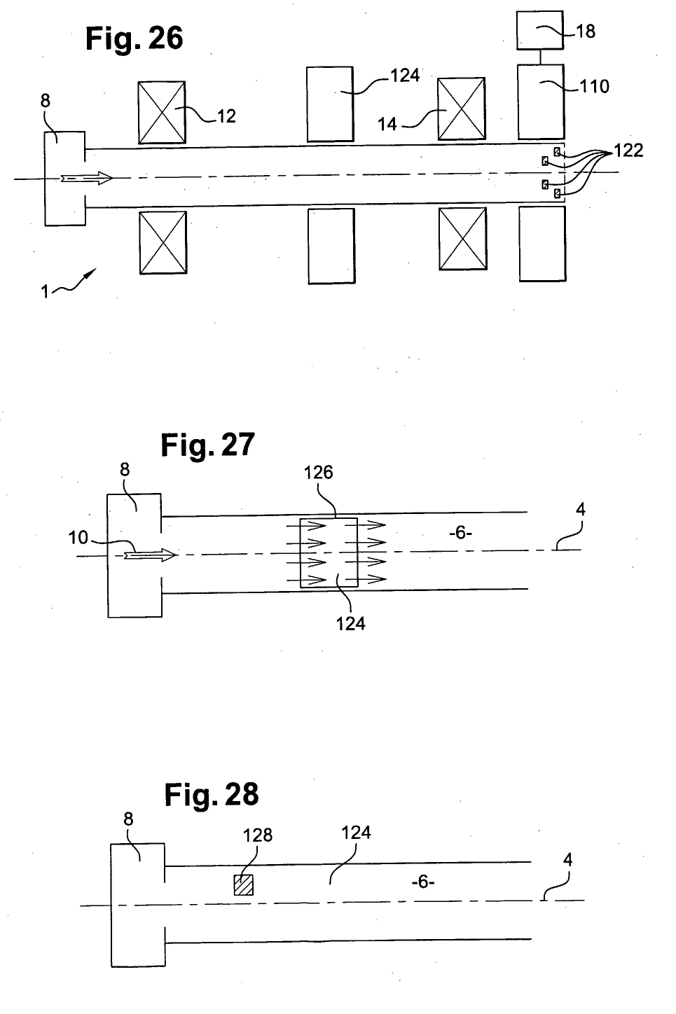

FIG. 26 is a schematic view in cross-section of a thruster according to another embodiment of the invention. FIG. 26 comprises solid material means 122 inside the resonant cavity 112 but outside of the main chamber 6. The solid material means 122 are adapted to modify the modes due to their electrical permittivity and/or magnetic permeability. Thus, these solid material means 122 are used to select and control the modes. The solid material means 122 are preferably outside of the main chamber 6 because, if they were inside the main chamber 6, they would be submitted to intense energetic ion bombardment. These solid material means 122 can be moveable so that they allow dynamic tuning of the resonant cavity. This improves the energetic coupling efficiency.

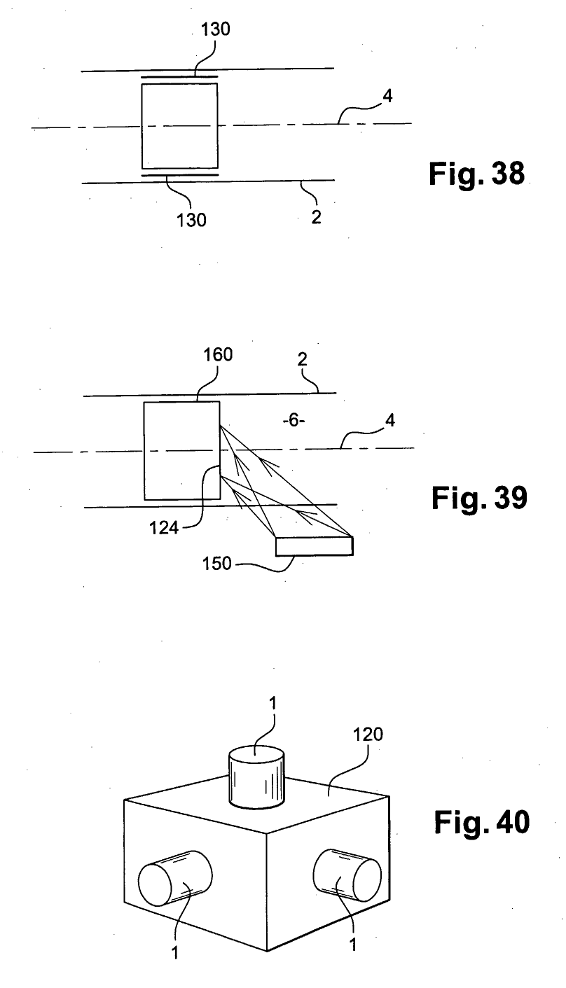

FIGS. 27-38 are schematic views in cross-section of various ionizers 124 of a thruster according to other embodiments of the invention. FIG. 27-38 comprise an injector 8 and an ionizer 124. The ionizer 124 of FIG. 27 comprises at least one metallic surface 126, said metallic surface 126 having a work function greater than the first ionization potential of the propellant. Such an ionizer is defined as contact ionization structure. This is described in “Contact Ionization Ion sources for Ion Cyclotron Resonance Separation”, Jpn. J. Appl. Phys. 33 (1994) 4247-4250, Tatsuya Suzuki, Kazuko Takahashi, Masao Nomura, Yasuhiko Fujii and Makoto Okamoto. Because it can be used as a primary provider of ions, a contact ionization structure can be used as an ionizer 124. A contact ionization structure consists of a metallic surface 126 in contact with the ionisable media, i.e. gas for instance, this can take the form of a porous metallic section through which the gas is injected inside the main chamber 6. A work function is defined as the minimum energy required to extract an electron from the solid material for example by photoemission. The propellant is ionized if its potential of first ionization is lower than the work function of the solid material surface.

FIG. 28 comprises an injector 8 and an ionizer 124. The ionizer 124 of FIG. 28 comprises at least one electron emitter 128. Indeed, ionization of injected gas may be obtained by submitting the injected gas to electron bombardment or electron impact. Indeed, when an electron and a neutral atom collide, if the kinetic energy of the electron is higher than the ionization energy of the atom, the neutral atom can be ionized. A very simple electron bombardment ionization structure can consist of an electron emitter 128 inside the main chamber 6. An electron emitter can be an electron-gun, a hot cathode, a cold cathode, a hollow cathode, a radioactive source, or a piezo-electric crystal. The greatest ionization probability is usually reached when the electron average kinetic energy is approximately equal to two to five times the ionization energy of the propellant. This means that to be more efficient the ionization structure should include means for increasing the kinetic energies of free electrons to this energy range—usually around 50 to 200 eV. Such an ionizer 124 comprising at least one electron emitter 128 is described in “The performance and plume characterization of a laboratory gridless ion thruster with closed drift acceleration”, AIAA Joint Propulsion Conference, AIAA-2004-3936, 2004 by Paterson Peter Y. and Galimore Alec D.

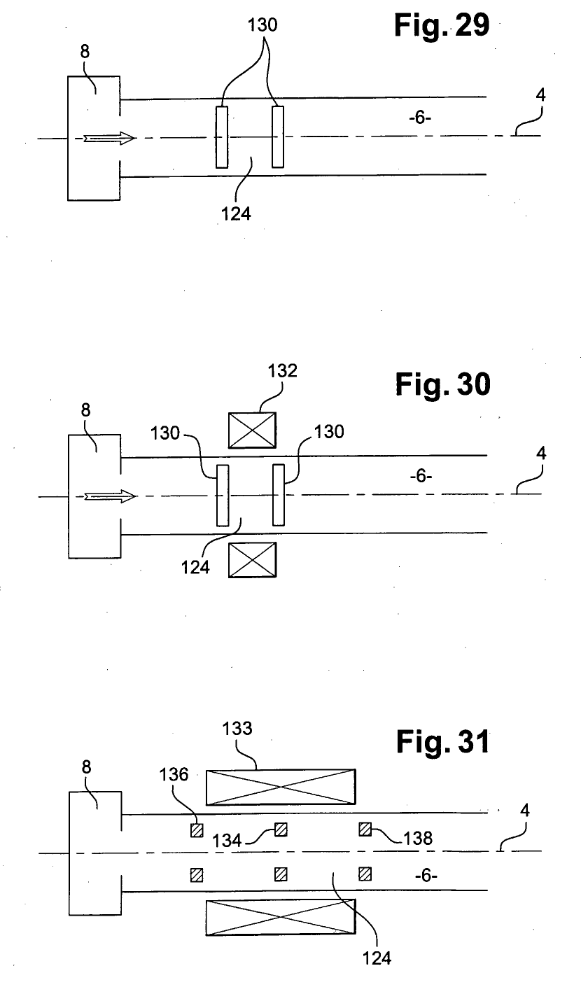

FIG. 29 comprises an injector 8 and an ionizer 124. The ionizer 124 of FIG. 29 comprises at least two electrodes 130 inside the main chamber 6, the said electrodes 130 having different electric potentials. This allows increasing kinetic energies of the electrons by applying them a permanent electric field. An ionizer 124 can comprise two electrodes 130 held at different electrical potential within the main chamber 6, the negatively charged one—a cathode—also acting as an electron provider and being preferably located adjacent to propellant injection to reduce the probability of ions impinging on the cathode and eroding it. Such an ionizer 124 comprising at least two electrodes (130) inside the main chamber 6, the said electrodes (130) having different electric potentials. In another embodiment, the thruster 1 comprises cooling means 167 adapted to remove heat from at least one compound of the thruster. In other words, the two electrodes 130 may be adapted to sustain large current, i.e. greater than 100 mA. Moreover, the rest of the system may be adapted to withstand the thermal effect associated with such large current by using passive or active cooling of the electrodes 130 and/or the tube 2 or any other part of the thruster 1. This allows to reach higher plasma density than lower current discharges. In another embodiment, a part of the heat removed from some compound of the thruster can be transmitted to the propellant to either change its state if not already gaseous or increase its thermal energy content hence its “cold thrust”. Such a cooling is called regenerative cooling.

FIG. 30 comprises an injector 8 and an ionizer 124. The ionizer 124 of FIG. 30 comprises at least two electrodes 130 inside the main chamber 6, the said electrodes 130 having different electric potentials, and a seventh magnetic field generator 132, adapted to generate a seventh magnetic field at least between the at least two electrodes 130. Ionization is improved by applying a seventh magnetic field to the ionizing area, because the seventh magnetic field makes the electrons gyrate around the magnetic field lines. Therefore, this increases the length of their path between the electrodes. Thus, this increases their probability to undergo an ionizing collision. Moreover, the first magnetic field generated by the first magnetic field generator 12, 14 may be also used as the seventh magnetic field generated by the seventh magnetic field generator 132.

FIG. 31 represents an injector 8 and an ionizer 124. The ionizer 124 of FIG. 31 is such that the at least two electrodes 130 comprise a ring anode 134 and two ring cathodes 136, 138, adapted to be respectively upstream and downstream of the ring anode 134. A seventh magnetic field generator 132, adapted to generate a seventh magnetic field at least between the electrodes 134-138 is also represented. This embodiment is named the Penning Discharge. This arrangement is such that electrons oscillate between the two cathodes. Thus, the paths of the electrons through the injected gas are longer. Such an ionizer 124 is described in F. M. Penning, Physica, 4, 71, 1937.

This embodiment may be combined with an eighth magnetic field generator adapted both to generate an eighth magnetic field and to create a bottle effect adapted to increase the intensity of the magnetic field around the cathodes regarding the intensity of the magnetic field around the anode. In this embodiment, the eighth magnetic field is non-uniform along the axis 4. This increases ionization. Moreover, the seventh magnetic field generated by seventh magnetic field generator 132 may be also used as the eighth magnetic field generated by the eighth magnetic field generator 133. Such an ionizer 124 is described in F. M. Penning, Physica, 4, 71, 1937.

FIG. 39 represents an ionizer 124. The ionizer 124 of FIG. 39 is such that the at least two electrodes 130 comprise two electrodes 130 delivering brief and intense current impulse along the surface of a solid propellant 160, thus ablating and ionizing a small layer of propellant 160 at each impulse. Preferably, the electrodes 130 remain in contact with the solid propellant downstream surface. This contact ensures best coupling efficiency because more energy is used to vaporise and ionise the propellant 160. For instance, the ionizer 124 can comprise two railed electrodes 129 parallel to the axis 4 and positioned along the main chamber 6 along the length of the solid propellant. As the propellant 160 is consumed, the downstream surface recesses, i.e. moves, toward the upstream end of the thruster 1. The railed electrodes 13 allows to have electrodes keeping contact with the downstream surface of the propellant 160. It is also preferred in this embodiment that such railed electrodes are connected to the generator by their downstream ends. This ensures that the discharge will more likely occur on the downstream surface of the solid propellant 160. Indeed, the downstream surface of the solid propellant 160 will offer a conducting path of lower inductance. Another possible embodiment would comprise electrodes 130 having a axial length much smaller than the thruster length, and means for pushing the solid propellant 160 to ensure that the downstream surface of the solid propellant 160 stay in contact with the electrodes 130.

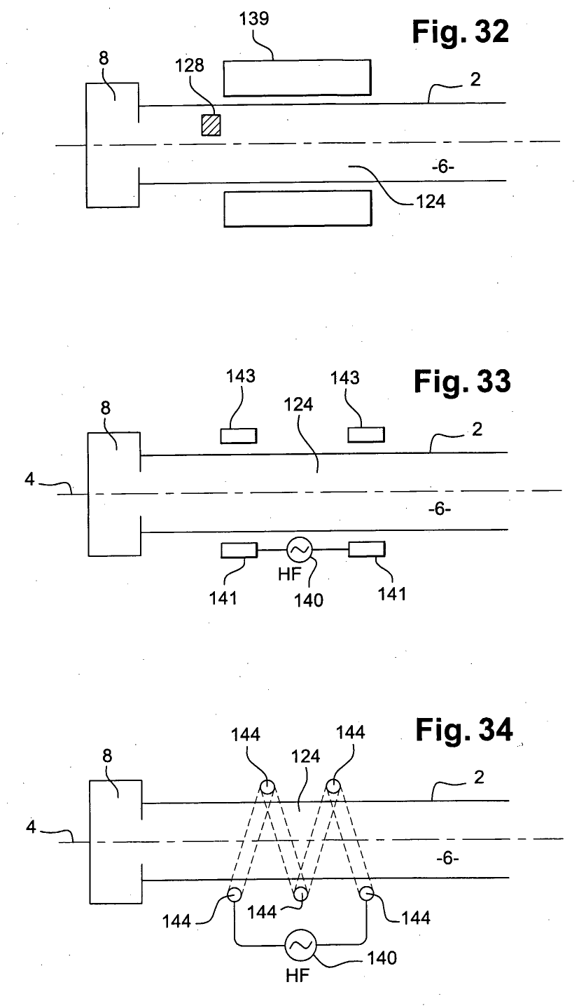

FIG. 32 comprises an injector 8 and an ionizer 124. The ionizer 124 of FIG. 32 comprises at least one electromagnetic field generator 140 adapted to produce an alternating electromagnetic field within the main chamber 6. Indeed, it allows to energize electrons, whether free electrons naturally existing in the gas or provided by an additional electron emitter 128, by applying them an alternating electric field for instance in using a coupling antenna, i.e. electrodes 139. Preferably, the frequency of the at least one electromagnetic field generator 140 is below 2 GHz. This allows to avoid interference problems with the payload, and especially communication means of a spacecraft comprising the thruster 1.

In the example of FIG. 33, the at least one electromagnetic field generator 140 comprises capacitively coupled electrodes 142 connected to a high frequency generator 140. Capacitively coupled electrodes 141 are defined as pairs of electrodes 141 having the different potentials. These capacitively coupled electrodes 141 are connected to a high frequency power source. In this embodiment, the coupled electrodes 141 are placed outside of the tube 2 containing the plasma, which then implies a capacitive discharge in which the electrodes 142 are not subject to any erosion due to particle impact. In the example of FIG. 33, there is tone pair 141 of ring coupling electrodes. In this capacitive discharge, no part needs to be in direct contact with the plasma as the coupling electrodes 141 can be outside the tube 2. Thus it reduces the erosion risk

In the example of FIG. 34, the at least one electromagnetic field generator 140 comprises an inductively coupled coil 144 connected to a high frequency generator 140. An alternating field is applied on the ionization area by using a coil fed with an alternating current. The alternating current creates an alternating magnetic field which induces an alternating electric field. Similarly to capacitive discharge in this inductive discharge, no part needs to be in direct contact with the plasma as the coil 144 can be outside the tube 2. Thus it reduces the erosion risk. Beside the obvious solenoidal geometry, alternative coils geometry can be used. Such an ionizer 124 is described in U.S. Pat. No. 4,010,400, Hollister, “Light generation by an electrodeless Fluorescent lamp” and in U.S. Pat. No. 5,231,334, Paranjpe, “Plasma source and method of manufacturing”.

Both these previous embodiments, i.e. capacitively coupled electrodes 142 and inductively coupled coil 144, may be improved with a ninth static magnetic field generated by a ninth magnetic field generator, and preferably when the frequency of the high frequency electromagnetic generator 140 used is near a plasma characteristic resonance frequencies such as the ions or electrons cyclotron frequency, the plasma frequency, the upper and lower hybrid frequencies because the energy transfer becomes more efficient.

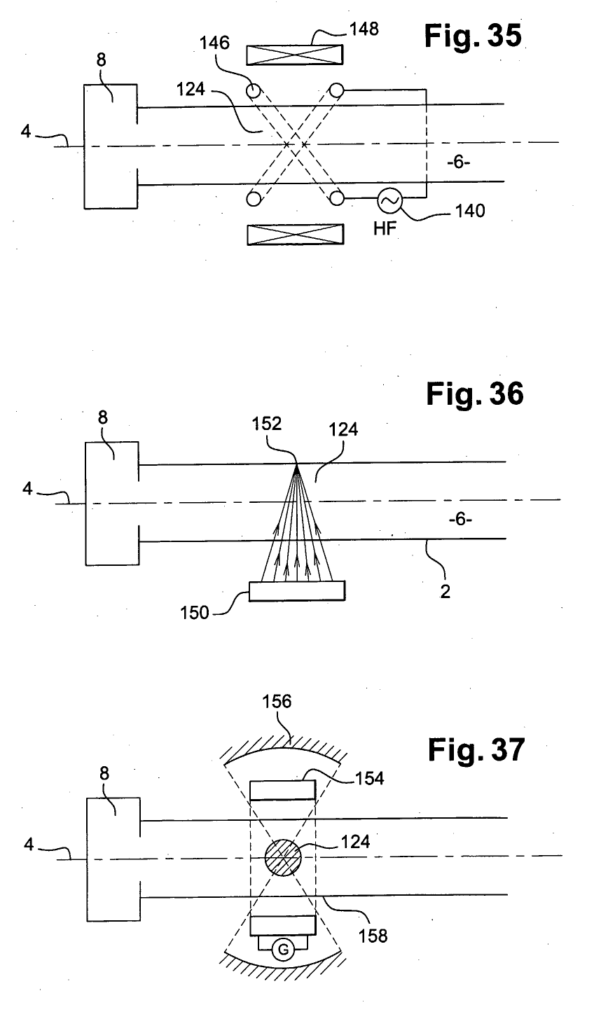

FIG. 35 comprises an injector 8 and an ionizer 124. The ionizer 124 of FIG. 35 comprises at least a helicon antenna 146 connected to a high frequency generator 140. FIG. 34 also comprises a tenth magnetic field generator 148 adapted to generated a tenth magnetic field generator substantially parallel to the axis 4 of the main chamber 6. Helicon type antenna and frequency are of interest as they allow to produce high density plasma. Such an ionizer 124 is described by R. W. Boswell, in “Very efficient Plasma Generation by whistler waves near the lower hybrid frequency”, Plasma Physics and Controlled Fusion, vol. 26, N° 10, pp 1147-1162, 1984; by R. W. Boswell, in “Large Volume high density RF inductively coupled plasma”, App. Phys. Lett., vol. 50, p. 1130, 1987; in U.S. Pat. No. 4,810,935, R. W. Boswell, “Method and apparatus for producing large volume magnetoplasmas”; and in U.S. Pat. No. 5,146,137, Gesche et al., “Device for the generation of a plasma”. In another embodiment any of the previously described high frequency ionizer, i.e. capacitive, inductive, resonant or helicon, can use at least one electron emitter 128 inside the main chamber 6. This has the advantages of making the initiation of the discharge easier, or/and allowing to reach higher plasma density.

FIG. 36 comprises an injector 8 and an ionizer 124. The ionizer 124 of FIG. 36 comprises at least one radiation source 150 of wavelength smaller than 5 mm, and adapted to focus a beam on a focal spot 152. First, this allows the focal spot diameter to be smaller than the diameter of the main chamber 6. Thus it allows such a focus diameter to be smaller than the typical distance between possible focus targets. On the contrary, i.e. if the wavelength is greater than 5 mm the diameter of the main chamber should be greater than 5 centimetres. This would imply that such a thruster 1 would produce a lower thrust density. Second, using a wavelength smaller than 5 mm also allows to reach pressure exceeding 1 Giga Pa inside the focal spot even with a radiation source of power lower than 500 W. Such a high pressure is desirable to produce dense plasma. Furthermore, the lower the power of the radiation source the higher the overall efficiency of the thruster 1. A radiation source 150 of wavelength smaller than 5 mm allows to produce a field intense enough to ionize and/or produce electron emission inside the main chamber 6 either inside a volume of the main chamber 6 (this is described in U.S. Pat. No. 3,955,921, Tensmeyer; U.S. Pat. No. 4,771,168, Gunderson et al.) or on the tube 2 (this is described in U.S. Pat. No. 5,990,599, Jackson et al.). In the example of FIG. 36, the focal spot 152 is on the tube 2 surface. There is also a transparent section in the tube 2 to let the waves pass through the tube 2.

In the example of FIG. 37, the focal spot 152 is a focal volume within the main chamber 6; the radiation source 150 comprises a flash lamp radiation source 154, and a reflector 156. There is also a transparent section 158 in the tube to let the waves pass through the tube 2.

FIG. 37 shows an embodiment, in which a radiation source 150 can be used to ionize the propellant by focusing a high intensity radiation on a small focal volume 152 inside the main chamber 6 in order to reach high pressure, pressure being defined as energy per unit volume. For instance, an example can be an intense cylindrical flash bulb surrounding the main chamber with the tube 2 made of a material mostly transparent to the wavelengths used (for example quartz for optical and UV wavelengths) in a similar fashion as those used to excite laser. Such radiation source can also be fitted with reflectors and/or lenses 156 to enhance the focusing effect. If the wavelength chosen is such that individual photon energy is equal or greater than ionization energy (mostly UV: wavelength lower than 450 nm hence of individual energy greater than 1 eV) then either the propellant can be ionized by photoionization or alternatively the radiation can be also focused on a solid surface inside the chamber in order to produce electrons by photoelectric effect. Another possible embodiment of such devices can be to direct a laser beam on a dedicated surface inside the chamber. This allows to produce plasma without any material part inside the main chamber 6. This also allows to reduce impedance adaptation problems or plasma density limit as found in RF and microwave systems, especially for systems where the plasma diameter size is much larger than the wavelength. These problems are due to plasma skin depth which induces shielding of the electromagnetic field. Moreover, the radiation source can be distant from the thruster and/or even from the spacecraft.

FIG. 39 comprises an ionizer 124. The ionizer 124 of FIG. 39 comprises at least one radiation source 150 of wavelength smaller than 5 mm, and adapted to focus a beam on a focal spot 152. The ionizer 124 of FIG. 39 further comprises at least a solid propellant 160, and the at least one radiation source 150 of FIG. 39 is adapted to focus on said solid propellant 160. Indeed, if the radiation intensity is high enough it is possible design a system in which the propellant (such as Na, Li) could be a stored in solid state inside the chamber and simultaneously vaporized and ionized by powerful laser impulse each vaporizing and ionizing a tiny layer of it. This arrangement allows to use any solid propellant without having to use a dedicated vaporization system and also to obtain extremely dense pulse of plasma.

In another embodiment of the invention, a system comprises at least one thruster and at least a microwave power source 114 adapted to supply the at least one thruster with power. Therefore, this allows to use a plurality of thruster together. Each one is supplied with energy by its own microwave power source 114, or by a unique microwave power source 114 for the plurality of thrusters, or a mixed system. It is also possible for the system to comprise a controller. Then, when a microwave power source 114 is off, or damaged, or cannot supply a thrust with enough energy, the controller may command another microwave power source 114 to supply this thrust.

The microwave power source 114 can be derived from the one used to allow microwave communications and or data transfer of a satellite. This allows the thruster to use a microwave power source 114 that exists on most satellites. Indeed, satellites have such a microwave power source 114 to communicate with Earth or to fulfill another mission.

FIG. 40 is a schematic view of another embodiment of the invention. FIG. 39 comprises a system comprising a spacecraft body 120 and at least one thruster 1 adapted to direct and rotate the spacecraft body 120. This thruster 1 can use thrust vectoring technology. Three thrusters 1 may be sufficient when arranged on three different sides of a spacecraft body 120 to allow the spacecraft body 120 to move along any direction and to rotate also regarding any direction, especially if they use thrust vectoring. When using two thrusters 1 on two sides of the spacecraft body 120, the thruster may rotate along only two directions. Yet, it can move along the three directions. This prevents also from using prior art thrusters which need to be mechanically gimballed on a side of a spacecraft body.

Process embodiments are deduced from these preceding thruster and system embodiments. The process embodiments have the same advantages as the thruster and system embodiments.

The invention is not limited to the various embodiments exemplified above. Notably, the various solutions discussed above may be combined. For instance, one could use any of the solutions for improving gas injection disclosed in reference to FIGS. 3-8 in combination with any of the solutions for improving thrust vectoring disclosed in reference to FIGS. 17-20. One may use coils for generating the various fields, or coil-less solutions like the ones disclosed in reference to FIGS. 9-16. One may also combine the various solutions disclosed for the same purpose, e.g. combine the gas injection solutions of FIGS. 5, 13, and 18. The currently preferred embodiments include:

a combination of the solutions of FIGS. 38, 25, and 21;

a combination of the solutions of FIGS. 35, 8, and 15;

a combination of the solutions of FIGS. 31, 4 and 19.

Combinations may also be realized using a ionizer 124 comprising at least an electromagnetic field generator adapted to generate a microwave ionizing field in the main chamber 6, the said microwave ionizing field which can be upstream of a maximum along the axis 4 of a magnetic field generated by a magnetic field generator.

1. A thruster comprising:
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis; and
an obstructer, located downstream of the injector and upstream of the main chamber, adapted to obstruct partly the main chamber.

2. A thruster further comprising:
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis,
wherein the injected ionizable gas is gas surrounding the thruster.

3. The thruster of claim 2, wherein the injector comprises at least a compression chamber.

4. The thruster of claim 2, wherein the injector comprises at least an expansion chamber.

5. A thruster comprising:
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis,
wherein the injector is adapted to inject ionizable gas at the location of the ionizer.

6. The thruster of Claim 5, wherein the injector is adapted to inject ionizable gas in the main chamber through at least a slot.

7. The thruster of claim 5, wherein the injector is adapted to inject ionizable gas in the main chamber through at least a hole.

8. The thruster of claim 5, wherein the injector is adapted to inject ionizable gas in the main chamber at least at one location along the main chamber.

9. A thruster comprising:
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field at least downstream of said ionizer along the direction of thrust on said axis; and
wherein the first magnetic field generator is coil less.

10. The thruster of claim 9, further comprising a first magnetic circuit made of materials with magnetic permittivity greater than the vacuum permittivity and adapted to generate a magnetic field substantially parallel to the axis of the main chamber.

11. The thruster of claim 9, wherein the magnetic field generator comprises at least one magnet.

12. The thruster of claim 9, wherein the magnetic field generator comprises at least one electromagnet.

13. The thruster of claim 9, further comprising at least a second magnetic field generator adapted to generate a second magnetic field and to create a magnetic bottle effect along the axis upstream of the magnetized ponderomotive accelerating field.

14. The thruster of claim 13, wherein the second magnetic field generator comprises at least a coil.

15. The thruster of claim 13, wherein the second magnetic field generator comprises at least a substantially axially polarized magnet

16. The thruster of claim 13, wherein the second magnetic field generator comprises at least a substantially axially polarized electromagnet.

17. The thruster of claim 9, further comprising a third magnetic field generator adapted to generate a third magnetic field, said third magnetic field having at least a third maximum along the axis, said third magnetic field generator at least overlapping the magnetized ponderomotive accelerating field.

18. The thruster of claim 17, wherein the first magnetic field generator and third magnetic field generator have a first common compound.

19. The thruster of claim 18, wherein the first common compound comprises at least a magnet.

20. The thruster of claim 17, further comprising a fourth magnetic field generator adapted to generate a fourth magnetic field, said fourth magnetic field having at least a fourth maximum along the axis, said fourth magnetic field generator being downstream of the third magnetic field generator.

21. The thruster of claim 20, wherein the fourth magnetic field generator and third magnetic field generator have a second common compound.

22. The thruster of claim 21, wherein the second common compound comprises at least a magnet.

23. The thruster of claim 21, wherein the second common compound comprises at least an electromagnet.

24. A thruster comprising:
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis; and
at least another magnetic field generator adapted to vary the direction of the magnetic field within the magnetized ponderomotive accelerating field.

25. The thruster of claim 24, wherein the another magnetic field generator comprises at least one electromagnet.

26. The thruster of claim 24, wherein the another magnetic field generator comprises at least one magnet.

27. A thruster comprising:
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis; and
at least another magnetic field generator adapted to confine ionized gas upstream of the magnetized ponderomotive accelerating field.

28. A thruster comprising:
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis; and
a securing member operably securing at least two compounds of the thruster.

29. The thruster of claim 28, wherein the securing member comprises at least a grid.

30. The thruster of claim 28, wherein the securing member comprises at least a plate.

31. The thruster of claim 28, wherein the securing member comprises at least a bar.

32. The thruster of claim 28, wherein the securing member comprises at least a web along the axis.

33. A thruster comprising:
a main chamber defining an axis of thrust;
an injector adapted to inject ionizable gas within the main chamber;
an ionizer adapted to ionize the injected gas within the main chamber;
a first magnetic field generator and an electromagnetic field generator adapted to generate a magnetized ponderomotive accelerating field downstream of said ionizer along the direction of thrust on said axis; and
at least one resonant cavity;
wherein the electromagnetic field generator is adapted to control the mode of the resonant cavity.

34. The thruster of claim 33, wherein the electromagnetic field generator further comprises a housing adapted to generate stationary electromagnetic waves within the resonant cavity.

35. The thruster of claim 33, wherein the housing is adapted to contain at least partly the resonant cavity.

36. The thruster of claim 33, further comprising solid material means within the resonant cavity, the said solid material means being adapted to control the mode of the resonant cavity.

37. A thruster comprising:
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis;
wherein the ionizer comprises at least one metallic surface, said metallic surface having a work function greater than a first ionization potential of the propellant.

38. A thruster comprising:
a main chamber defining an axis of thrust;
a device operably providing ionizable propellant within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on the said axis;
wherein the ionizer comprises at least one electron emitter.

39. A thruster comprising:
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on the said axis;
wherein the ionizer comprises at least two electrodes inside the main chamber 6, the said at least two electrodes having different electric potentials.

40. The thruster of claim 39, wherein the at least two electrodes comprise a ring anode and two ring cathodes, adapted to be respectively upstream and downstream of the ring anode.

41. The thruster of claim 39, further comprising a seventh magnetic field generator, adapted to generate a seventh magnetic field at least between the at least two electrodes.

42. The thruster of claim 41, wherein the seventh magnetic field generator is adapted to generate a magnetic bottle comprising the at least two electrodes.

43. A thruster comprising:
a main chamber defining an axis of thrust;
an ionizer adapted to provide ionized propellant within the main chamber; and
a first magnetic field generator and an electromagnetic field generator adapted to generate a magnetized ponderomotive accelerating field downstream of said ionizer along the direction of thrust on the said axis; and
a cooler adapted to remove heat from at least one compound of the thruster.

44. A thruster comprising:
a main chamber defining an axis of thrust;
an ionizer adapted to provide ionized propellant within the main chamber; and
a first magnetic field generator and an electromagnetic field generator adapted to generate a magnetized ponderomotive accelerating field downstream of said ionizer along the direction of thrust on the said axis;
wherein the ionizer is adapted to ablate and ionize a solid propellant.

45. The thruster of claim 44, wherein the ionizer comprises at least two electrodes adapted to deliver current pulses along the said solid propellant surface.

46. The thruster of claim 45, further comprising at least one radiation source is adapted to focus on said solid propellant surface.

47. The thruster of claim 44, further comprising at least an electron beam source is adapted to focus on said solid propellant surface.

48. A thruster comprising:
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis;
wherein the ionizer comprises at least one electromagnetic field generator adapted to apply an alternating electromagnetic field within the main chamber.

49. The thruster of claim 48, wherein the at least one electromagnetic field generator comprises capacitively coupled electrodes.

50. The thruster of claim 48, wherein the at least one electromagnetic field generator comprises an inductively coupled coil.

51. The thruster of claim 48, further comprising a ninth magnetic field generator adapted to generate a ninth static magnetic field where injected gas is ionized.

52. The thruster of claim 48, further comprising a tenth magnetic field generator adapted to generated a tenth magnetic field generator substantially parallel to the axis of the main chamber, and wherein the at least one electromagnetic field generator comprises at least a helicon antenna.

53. The thruster of claim 48, wherein the ionizer comprises at least one electron emitter.

54. A thruster comprising:
a main chamber defining an axis of thrust;
an injector adapted to inject ionizable gas within the main chamber;
an ionizer adapted to ionize the injected gas within the main chamber; and
a first magnetic field generator and an electromagnetic field generator adapted to generate a magnetized ponderomotive accelerating field downstream of said ionizer along the direction of thrust on said axis;
wherein the ionizer comprises at least one radiation source of wavelength smaller than 5 mm, and adapted to focus an electromagnetic beam on a focal spot.

55. The thruster of claim 54, wherein the ionizer is adapted to focus within the main chamber.

56. The thruster of claim 54, further comprising a tube comprising at least partly the main chamber, and wherein the ionizer is adapted to focus on the wall of the tube.

57. A system comprising:
at least one ionizing gas thruster; and
at least one microwave power source adapted to supply with power the at least one thruster.

58. The system of claim 57, further comprising a satellite, wherein the at least one microwave power source is used for microwave communications of the satellite.

59. The system of claim 57, further comprising a satellite, wherein the at least one microwave power source is used for data exchange of the satellite.

60. A system comprising:
a spacecraft body;
at least one ionizing gas thruster operably moving spacecraft body through at least one of: directional and rotational movement.

61. A process for generating thrust, the process comprising:
injecting a gas within a main chamber;
obstructing partly the main chamber;
ionizing at least part of the gas; and
subsequently applying to the gas a first magnetic field and an electromagnetic field for accelerating the partly ionized gas due to the magnetized ponderomotive force.

62. A process for generating thrust, the process comprising:
injecting gas surrounding a thruster within a main chamber;
ionizing at least part of the gas; and
subsequently applying to the gas a first magnetic field and an electromagnetic field for accelerating the partly ionized gas due to the magnetized ponderomotive force.

63. The process of claim 62, further comprising a compressing step of the gas surrounding the thruster before the injecting step.

64. The process of claim 62, further comprising an expanding step of the gas surrounding the thruster before the injecting step.

65. A process for generating thrust, the process comprising:
injecting gas within a main chamber;
ionizing at least part of the gas; and
subsequently applying to the gas a first magnetic field and an electromagnetic field for accelerating the partly ionized gas due to the magnetized ponderomotive force;
wherein the first magnetic field is applied without using a coil.

66. The process of claim 65, further comprising, after applying to the gas a first magnetic field and before applying to the gas an accelerating electromagnetic field, a step of applying a second magnetic field for creating a magnetic bottle effect, upstream the accelerating electromagnetic field.

67. A process for generating thrust, the process comprising:
injecting gas within a main chamber;
ionizing at least part of the gas;
subsequently applying to the gas a first magnetic field and an electromagnetic field for accelerating the partly ionized gas due to the magnetized ponderomotive force; and
subsequently applying to the gas a fifth magnetic field for varying the direction of the upstream first magnetic field.

68. A process for generating thrust, the process comprising:
injecting gas within a main chamber;
ionizing at least part of the gas;
subsequently applying to the gas a first magnetic field and an electromagnetic field for accelerating the partly ionized gas due to the magnetized ponderomotive force; and
subsequently applying to the gas a sixth magnetic field for confining the ionized gas upstream of the magnetized ponderomotive accelerating field.

69. A process for generating thrust, the process comprising:
injecting gas within a main chamber;
ionizing at least part of the gas; and
subsequently applying to the gas a first magnetic field and an electromagnetic field for accelerating the partly ionized gas due to the magnetized ponderomotive force;
wherein the ionizing step further comprises a step of applying an alternating electromagnetic field within the main chamber.

70. A process for generating thrust, the process comprising:
injecting gas within a main chamber;
ionizing at least part of the gas; and
subsequently applying to the gas a first magnetic field and an electromagnetic field for accelerating the partly ionized gas due to the magnetized ponderomotive force;
wherein the ionizing step further comprises a step of applying an alternating electromagnetic field of wavelength smaller than 5 mm within the main chamber, and for focusing a electromagnetic beam on a focal spot.

71. A process for generating thrust, the process comprising:
injecting gas within a main chamber; ionizing at least part of the gas; and
subsequently applying to the gas a first magnetic field and an electromagnetic field for accelerating the partly ionized gas due to the magnetized ponderomotive force;
wherein the ionizing step further comprises a step of bombarding the gas with electrons.
